(19) United States
(12) Patent Application Publication
(10) Pub. No.: US 2020/0193475 A1
(43) Pub. Date: Jun. 18, 2020

(54) APPARATUS, METHOD AND SYSTEM FOR REPLACING ADVERTISING AND INCENTIVE MARKETING

(71) Applicant: FOREST ZUKERMAN, LOS ANGELES, CA (US)

(72) Inventor: FOREST ZUKERMAN, LOS ANGELES, CA (US)

(21) Appl. No.: 16/672,306

(22) Filed: Nov. 1, 2019

Related U.S. Application Data
(63) Continuation of application No. 15/360,754, filed on Nov. 23, 2016, now abandoned.
(60) Provisional application No. 62/260,450, filed on Nov. 27, 2015.

(51) Int. Cl. G06Q 30/02; G06Q 50/00

(52) U.S. Cl. CPC G06Q 30/0252; G06Q 50/01; G06Q 30/0273

(57) ABSTRACT

A method and system for replacing advertising is provided herein, whereby users are selected to participate in events based on user attributes and event sponsor criteria. Accordingly, event sponsors may target intended audiences by sponsoring and then populating or casting an event with participants meeting desired criteria. Once assembled, the sponsor may exchange information with the participants and participants may exchange information with one another. Participant criteria may include personality and appearance attributes, popularity, reputation, number of social media followers, tastemaker status and overall ability to influence the opinions, perceptions or actions of other potential participants. Event sponsors may focus spending to assemble the largest, relevant cast desired, efficiently, through the use of geo-located devices associated with participants under control of software associated with the present invention. As opposed to broadcast advertising, the present invention enables spending money only to engage desired participants.

This application is a continuation of U.S. patent application Ser. No. 15/360,754, filed Nov. 23, 2016, which claims priority from U.S. Provisional Patent Application No. 62/260,450, filed on Nov. 27, 2015, the contents of which are incorporated herein by reference.

### BACKGROUND OF THE INVENTION

A problem exists with motivating people to participate in events or even appear for marketing or casting activities. Assembling a group of one or more social media users for inclusion in or attendance at sponsored events is increasingly difficult, as social media users are bombarded with events to attend or social invitations that look “personal” but are in reality broadcast to a large number of people. Accordingly, advertisers often reach the “wrong” people with email blasts, text blasts or social media blasts that do not achieve their intended result.

The Internet has become a major platform for exchanging goods and information, and has been used for, e.g., online shopping, online auction, photo album sharing and social networking. As a result, online advertising is becoming more and more important for advertisers in general. Typically, an advertiser may pay a publisher of a website a certain amount of money for displaying its advertisement for a certain period of time, assuming that users of the publisher's website may be interested in its advertisement. However, such advertisements are static, and users may not look at the advertisements at all. In addition, although currently available systems allow advertisers to roughly analyze interests of users of a publisher website, and target its advertisements at users of the publisher website, the targeting usually is not precise enough.

Word-of-mouth advertising (marketing) refers to the passing of product information in an informal, person-to-person manner, especially in the form of recommendations. The product information may be passed on via various channels, such as during face-to-face conversations, over telephones, via emails, text messages, online chats and/or posts, versus published magazines, newspapers, broadcast television and billboards, etc. Word-of-mouth marketing can be very effective, and thus is highly valued by advertisers. Many people, both consumers and marketers, believe that this form of communication has valuable source credibility. Research has shown that individual consumers are more inclined to believe word-of-mouth marketing than other more formal forms of promotion methods because the receivers of the word-of-mouth information tend to believe that the senders, often families, friends, or colleagues of the receivers, are speaking honestly and are unlikely to have any ulterior motives. However, people have become aware that messages designed to look “word of mouth” actually are not. They have become and are becoming more and more desensitized to blast or broadcast media. Electronic advertising is fast losing its efficacy.

Social networks, or social utilities that track and enable connections between members (including people, businesses, and other entities), are in widespread use. In particular, social networking websites allow members to communicate information more efficiently. For example, a member may post contact information, background information, job information, hobbies, and/or other member-specific data to a location associated with the member on a social networking website. Other members can then review the posted data by browsing member profiles or searching for profiles including specific data. The social networking websites also allow members to associate themselves with other members, thus creating a web of connections among the members of the social networking website. However, people are learning to disregard obvious outreaches for their time and effort. People are fast taking the position that “if you want me to listen what will you offer me?”

While these social media connections among members could be exploited by advertisers or those wishing to cast people for inclusion in various activities or events, social media often presents “overload” conditions whereby social media users are being approached in an unfiltered manner. Furthermore, many social media request recipients are left to ask “what's in it for me” if I attend a certain event or event casting? What is needed is a way for event notification recipients to filter “what will benefit me” and “how much can I make”. What is also needed is a way for advertisers or event sponsors to sort through all the social media users and then, ascertain how much it will cost to populate events with the “right” event participants or the right people to audition for a part in order to become a member of the cast intended. In addition, event sponsors need to know what it will take to populate events with the “right” people or true social influencers.

Social media already groups members according to one or more common attributes in their profiles, such as geographic location, employer, job type, age, music preferences, interests, or other attributes. Members of the social networking website or external parties can then use these groups to customize or target information delivery so that information that might be of particular interest to a group can be communicated to that group. What is needed is a way to strategically analyze this social media data, to determine who major social influencers are. That is, which users have many followers who themselves are part of a desired target audience desired to be reached by an event sponsor. The higher the score of a particular of a potential sponsored event participant, typically, the more difficult it may be to get him or her to attend a sponsored event. Accordingly, a need exists to take advertising revenue and channel it in the form of incentives, consisting of credits, cash or merchandise, to be given to selected users to become sponsored event participants.

Advertisers have attempted to leverage social media information about members, targeting their ads to members whose interests best align with the ads. For example, a social networking website may display banner ads for a concert to members who include an affinity for the performing band in their website profile and live near a concert venue where that band might be performing. However, these attempts are no different than targeting of ads that exist in many other contexts. Advertisers have not yet been able to exploit the relationships and connections among members of a social networking website in a meaningful way to present their advertising message to consumers.

Venues have a desire to attract desirable new customers and brand representatives to their locations or events, simultaneously maximizing on-sire spending by customers and to minimize the overall marketing expenditure to achieve increased brand awareness. To date, venues have been limited to traditional advertising mediums to target audiences, with the inherent limitations in targeting criteria and accuracy in achieving ideal results.

### SUMMARY OF THE INVENTION

With the present invention, the base of users from which to select sponsored event participants is typically social media like Twitter, Yelp, Facebook and Instagram, etc. Through the use of the present invention, social networking websites and other websites in which users assemble lists of friends and characteristics, are used to create user scores from which sponsored event participants may be selected. Therefore, according to the present invention, potential sponsored event participants may be scored and then selected to form a cast of characters or participants at an event, a process known as CROWDCASTING™.

The present invention relates to methods and computer program products for gathering online or real life audiences. The process of gathering an audience is akin to conducting a casting call to assign parts in a motion picture. According to the present invention, a select group of targeted participants are assembled at a sponsored event through the use of CROWDCASTING™.

By use of the present invention, sponsors may create events and then populate those events with a select group of social media users who become sponsored event participants, forming a cast or group of participants for that event. In classic, well-known terms, the present invention may be used by a movie production company to cast parts in a new movie. By using the present invention, user history, statistics, previous performance or appearance data, biometric data, physical appearance, attitude, strengths and weaknesses can be scored, and then a casting director can select who may be available nearby to audition for the part. Hence, the term CROWDCASTING™ is appropriately used according to the present invention.

According to the present invention, a metadata-rich, geo-centric database of opt-in consumers who provide a cross section of socio-graphic, demographic and behavioral characteristics is provided. When venues or venue sponsors seek to draw people into an event, or cast the event, or otherwise desire to draw people into any facility of any size from the largest stadium to the smallest private residence, the present invention provides structured filtering of potential audience participants, whereby “must have” criteria may be met such as age, gender, and affinities for specific complementary brands or lifestyles.

More specifically, the present invention relates to methods and computer program products for replacing traditional advertising, by targeting particular social media users to become participants in online or real life sponsored events. By use of the present invention, sponsors may assemble a targeted audience more efficiently than with broadcast advertising, based on the user's social network characteristics, quality, strength and ratings from participation in previously sponsored events, so that true social influencers may be assembled to get word out for the benefit of an event sponsor, thereby improving the odds that a sponsor will connect with its intended targeted audience. The present invention is a vast improvement over traditional word-of-mouth advertising.

After creating a subsection of an audience that is both geographically desirable for a given event and meets all of the “must have” criteria set by the event sponsor, an event target list is developed which is actually much larger than the ultimate list of actual event attendees. At that point, business realities may be employed to select the optimal list of attendees or desired attendees that are a relatively close fit for the business or personal purpose established by the event sponsor. For example, a business can choose to maximize first-time attendees, maximize social media influencers, or minimize cost.

Based on various relevant business objectives, the present invention may assign appropriate weights to individual users who are among a group in an amount that form the universe of potential event participants. Then, automatically, outreach is made to a random selection or planned selection of users with higher weighted scores and then an event is filled one optimal user or a group of optimal users at a time, based on which users have indicated they are available for an event. The automatic casting of an event may be referred to as AUTOCASTING™, when implemented according to the present invention.

The concept of automatically filling an event with the optimal group of attendees is a principal feature of the present invention. It represents a significant improvement of over the prior art in several respects wherein it supports micro-targeting customers based on socio-graphic, demographic and behavioral attributes previously unavailable to event organizers or sponsors, reserved only for online marketing platforms. Furthermore, the present invention highly automates the process of optimal audience selection based on any desired number of criteria as set forth herein. Optimal use of the present invention is achieved by taking into account user location, event location, user availability and a willingness of a user to participate in a given sponsored event, based on whether compensation is offered to the user and the amount and what kind of compensation is offered to an event participant by and event sponsor.

According to the present invention, human bias is removed from traditional casting or the process of creating social event invitations, or generally with respect to invite-only based event management. Often, personnel take their own bias into a job and therefore, the present invention eliminates that problem. Finally, the present invention provides an increased amount of internally generated meta-data, which can be used to further improve the performance of the platform according to the present invention as usage increases over time. In short, invention system users and invention event sponsors each gain more and more efficiency through extended and repeated usage of the present invention.

By way of example, a beverage company introducing a new beach oriented summer beverage can sponsor a launch party, and then populate that party with physically attractive models who look good in swimwear who also happen to possess large numbers of social media followers to portray a certain degree of social relevancy, which in turn may be electronically captured and-or leveraged to create a sense of popularity or success to enhance brand association. That is, in that example, a successful “good looking” launch party could mean that the beverage being launched is equally superlative.

The present invention may be used to fill seats at a baseball game, fill a restaurant or nightclub, “dress up” a house party, or may even provide an interesting wine tasting or private dinner at a residence. Event sponsors pay users to become event participants or attendees; and once they attend, event participants are rated so that as the present invention is used over and over, more data becomes apparent as to potential event participants. Likewise, if desired, a system according to the present invention may allow users to learn what event sponsors are best based on prior experiences, compensation, and surroundings such as level of luxury of a venue, quality of other event attendees, quality of food and beverage services at a given venue, and so forth.

Various embodiments of the present invention relate to systems and methods for conducting marketing activities among online social media users or event sponsors who wish to reach said online social media users. Event sponsors may be companies desiring to populate a party or marketing event with a certain quality or style of participant in order to associate that quality or look with a particular brand or product. According to the present invention, users within a social network are categorized with respect to their own individualized qualities or characteristics, based on for example appearance, ethnicity, geo-location, domicile, past behavior at previously attended sponsored events, age, popularity, number of followers, reputation and social leadership or social influencer status, etc. The user characteristics as to appearance and personality and all other desired characteristics can in turn be taken into account according to the present invention are then blended together to form an overall score.

One embodiment of the present invention allows for the curation of participant actions at an event. For example, event attendees may participate at a marketing event by using their smartphones through digital interaction at a live event, such as uploading, downloading or viewing digital content. The present invention encourages attendee participation at experience based events by offering incentives, including but not limited to monetary incentives or user account rewards. Event sponsors have the option of offering extra incentives based on attendees' participation and event engagement. The event sponsor is able to curate participant actions by outlining what specific actions qualify for incentives. For example, the sponsor can decide on quotas such as amount of uploads or downloads completed by a participant to obtain the incentives.

In short, the present invention may be used to motivate people to join groups or actually attend physical events. Event participants will according to the present invention, have his or her Facebook, Instagram and other social media indicia merged and scored, so that when sponsors seek to create an event and populate it with participants, sponsors may utilize selection criteria they deem most important.

Typically, sponsors will select a venue for their event. Consequently, the sponsor must decide on a budget. Generally, the sponsor of an event will use traditional advertising budget dollars to instead engage the present invention. In that manner, the present invention may often be seen as a replacement for traditional advertising. When a sponsor decides on an event venue, indirectly, the overall quality level of the event is established. If the event is held in a normal middle class home for example, sponsors may need to do more to entice the most selective social media users to become sponsored event participants. Conversely, if the event is to be held at one of the most famous addresses in a given country, such as the White House, then the event sponsor will expect to be able to entice practically any selected social media user to attend a sponsored event. So that event sponsors need not “blow their bank” on securing the most expensive or prestigious event venue, according to the present invention, an event sponsor may opt to make available payments to social media users in order to entice them to attend a sponsored event as a participant.

An event sponsor may be one person looking for an audience of one person, such as a recently single Fortune male CEO, looking for an accomplished, interesting dinner companion. More likely, a film production company may use the present invention to entice selected social media users who display particular attributes or qualities to attend a casting call for parts in an upcoming movie. Moreover, a national beverage company may use the present invention to launch a new line of beverages. For example, if the beverage is a “summer” or “beach” oriented beverage, then the present invention may be used to CROWDCAST™ a the launch party so that a number of beautiful atmosphere models are in attendance. In turn, by brand association, an event sponsor may feel this result is advantageous. That is, such an event may make the beverage look its best to the outside world. In this example, the event sponsor may instruct event participants to dress in beach attire and may only select individuals for the cast who look outstanding in swimwear.

According to the present invention, event participants may be scored or rated once they show up at events for which they have been cast. They may be scored based on their appearance, the impression they make, the sincerity, friendliness and so forth. These ratings may become part of the “background” record for that social media user so that for future events, event sponsors know which event participants are better than others. In turn, the highest rated social media users may require more compensation in the future to attend various future sponsored events. Compensation may also be paid to certain event participants to serve as organizers or ambassadors of the operator of the present invention or its event sponsoring customers or clients. In turn, certain event participants can get paid to attend an event or even paid to organize other event participants. Payment or compensation may be in the form of cash, electronic payment or wire, PayPal or Chimp Change, merchandise credits, gift cards, or any other article of value.

A marketing system according to the present invention is far more effective than traditional targeted online advertising. A social networking website uses the information it obtains about its members' actions and their connections to other members of the website. Rather than merely deliver a message that is targeted to a particular member based on the member's preferences, embodiments of the invention provide direct compensation to the “right” users. Only the event sponsor establishes who defines who the “right” social media user is as event participants are selected. Therefore, instead of advertising widely or broadcasting, individual “in demand”, “hot”, tastemakers, social leaders, celebrities or true social influencers may be targeted and then compensated to populate a sponsored event.

Social ads allow advertisers to leverage one member's actions to promote specific content to others who might be interested in that information—not only because they might have similar interests, but also because of their connection with the member. This mode of advertising may be more effective because members are more likely to be influenced to respond to an advertiser's message in the presence of information that their friends or other connections have also taken an action related to the advertiser. Social ads thus allow advertisers to enjoy the credibility that consumers naturally give to their friends through word of mouth advertising. Beyond simple targeting of ads that merely chase demand, therefore, this approach is better able to create or generate demand by providing the socially related information to members about their friends' actions.

In one embodiment, a social networking website collects and logs information about actions taken by members of the website. These logged actions may be actions in connection with the social networking website and/or its members, with another website, or real world actions captured and communicated to the social networking website. Nonetheless, the present invention improves over the most successful word of mouth advertising. By compensating and then rating event participants, event sponsors who utilize the present invention to populate events can compensate the “right” people to be paid the “right” amount of money to attend the “right” events, and then, build a performance history as to each event participant for future reference and evaluation and grading.

User background information can be as detailed as desired, adapted to serve event sponsor needs. Users may enter their name, email address, phone number, street address, birth date, photograph, Facebook, Yelp, Twitter and Instagram data, payment receipt preferences such as PayPal or ChimpChange, event attendance preferences such as nightclubs, bars, wine bars, focus groups, promotional modeling, group or 1 on 1 interaction, along with physical attributes such as hair color, hair length, piercings, tattoos, union or association memberships, ethnicity, eye color, body type, personality type. In addition, as users become selected to participate in events and then become event participants, they may be scored based on presentation (initial appearance) and engagement (social interaction at an event, etc.).

According to the present invention, the two important groups are users and event sponsors. Event sponsors may decide to elevate the status of certain users to the role of an event manager or ambassador. Event types may include atmosphere model grouping or casting (nightclubs, private parties, restaurants or private residence host), back grounding casting (usually for film or television production), social media (ambassador or representative of a particular brand or point of view), promotional model (typically brand associated), or any other use for a personal representative or spokesperson.

An invention system user who desires to attend events may be referred to as an event “goer”. A “goer” will typically download an “app” to become an approved user. Next, a “goer” will receive an availability request with an incentive or offer of compensation. Then, the system platform according to the present invention will request a “goer” accept or decline a request to attend an event or join a cast. Based on how many suitable “goers” are availability, by geography, and taking into account all the sponsored events in that given geographic location, and taking into account user characteristics and event sponsor desired criteria, the system platform according to the present invention will ascertain which “goers” may or may not be directed to attend various sponsored events, also under control of the present invention.

Event sponsors may also be referred to as “producers”. “Producers” may run local events or venues and have the ability to “cast” their ideal audiences. Depending upon the event or venue, or previous experiences or the “producer's” unique profile, the present invention will cast or create the perfect group of people or attendees for a given event. “Producers” would typically need to sign up in advance, get approved and then, define its ideal audience. All of this may be done via and “app”. According to the present invention, hand held mobile devices are almost always the way users or “goers” and event sponsors or “producers” take advantage of the present invention.

The present invention takes advantage of the power of crowd sourcing in order to connect business interests, social interests and personal interests. Event sponsors or “producers” can cast or fill events with desired users or “goers”. Facebook profiles, for example, may be used to facilitate this process. Instead of event sponsors spending money advertising, which is often not optimally targeted, the money may be used to pay users or “goers” to attend the event. So if you need atmosphere models for a dinner, you can spend money advertising, or better yet, according to the present invention, the “producer” or event sponsor may simply pay the “goers” in hand. “Goers” may strategically include social “influencers” who social media indicates desire, for example, to have fun, and who in turn draw in more and more people who like to have fun. According to the present invention, the long known practice of paying people to “promote” events is better handled automatically, with that money paid to event attendees or “goers”, who are also social influencers.

Facebook, Inc., describes a method titled: Search powered connection targeting, in U.S. Pat. No. 9,020,835, whereby a social network is used by the advertiser to extend the audience outreach for an advertisement by using seed objects that suggest the targeting criteria for the ad. A seed is described as a keyword associated to the desired target audience and social media user. These seed objects are identified by a system through a social graph, calculating similarities between seed objects and candidate objects, whereby targets are then suggested by the social network system.

The fact that nearly everyone has a social media interface on his or her respective handheld device, and these devices all contain geo-location devices, makes possible the present invention. By use of the present invention, the event title or venue may be placed on a “goer's” calendar, along with all the event details. For example, a “goer” may be told how to dress or not dress (no shorts, no sandals, etc.). The date and time of an event may be stored by a “goer” well in advance, whether the “goer” has been cast or not. A “save the date” may be issued so that a maximum number of potential event participants are set aside “ready” to be cast. Arrival instructions about where to check in, etc. may be organized, as well as transportation to and from an event, for example, via Uber.

Event details may be very detailed, including, how to act at a given event, and maybe even as to what certain event participants are asked to say. For example, if launching a new musical group, attendees may be asked to be very enthusiastic when the group performs. In real time, event sponsors may add to the number of “goers” desired, so that in one night, more event participants may be drawn to an event, or, a certain “in demand” event participant may be compensated to migrate from event to event. Venue or event times and locations, requirements and details may be specified, and event participants may be routed so that distances that must be traveled are optimized. For example, in order to be paid, a “goer” may be required to attend an event, speak to a certain number of people and stay for a minimum amount of time. After a “goer” attends an event, he or she may be rated based on their initial appearance or presentation, and then their engagement while at the event, to be used for future castings. Then, depending upon what other on-going events still require “goers”, the event participant or “goer” may be prompted and routed to the next event. Transportations providers such as Uber may enable said transportation. More particularly, push notifications may be utilized to direct users or event participants where to be at a particular time or when a response is needed; and similarly, event sponsors may be prompted as top steps required to advantageously curate their particular events.

The present invention may also incorporate a central administration module for use by event sponsors or “producers”. For example, on a given night, a “producer” may be producing events at multiple venues. Yet, a “producer” may have a certain budget either per event or to cover multiple events. Accordingly, “producers” have the option to cast certain event participants based on cost on how their cost fits in with an overall budget. The budget may be set so that a “producer” may optimize how much money is to be spent per venue and per “goer”. Bonus payments may be offered to “goers” who go above and beyond the event requirements, and, “goers” may offer to attend various events at discounts. In short, the supply and demand of “producers” or event sponsors and “goers” and system platform users or event participants may be satisfied, whereby compensation is established to be at equilibrium or at a fair market rate.

The present invention may also incorporate a sort of administration or dashboard for event participants or “goers” as well. It is anticipated that many event participants who utilize the present invention will come to rely on its use as a way to generate necessary sustainable income. In that way, top rated users may become event organizers or ambassadors and may optimize how many events they attend or participate in per unit of time. Time management may thereby be achieved by use of the present invention, whereby a person who is the “life of the party” may hereinafter be fairly compensated for serving and performing in that capacity. Social influencers are typically in demand so with the preset invention, social influencers may make the best use of their time depending upon the level of compensation they receive per unit time. Furthermore, “goers” may track their earnings and track their ratings to insure they maintain the best possible reputation for future castings.

The present invention can be accessed across multiple platforms, including mobile smartphone devices, mobile tablet devices and wearable technology such as a smart watch that syncs with a mobile smartphone device or interactive glasses that allow the user to store data on an external server. A smart watch can function as a geolocation and tracking device for the user. Interactive glasses function as a means of checking in to a location and collecting photographic data of the event.

The member score is a feature that is implemented in order to promote the qualities and behaviors that make up an ideal member. Each member earns a score based on their overall reliability and performance. Having a good score is necessary to attend the most in-demand events. The factors that make up a member score include: number of events attended; number events where the member did not show up; number of cancelled events including how much time left before the start of the event; frequency of response to availability requests; events not accepted or responded to; frequency of engagement; engagement rating given by event ambassadors; and relative engagement history.

In accordance with the present invention, a complete member profile consists of information obtained from: profile data input by the user; data gathered from third party social media profiles; data observed and aggregated from peer reviews and comments; and behavioral data obtained through member engagement and application use. During the creation of the member profile, the member enters key information including member name, birthdate, gender, email, and phone number. The member must also upload several photos. The entertainment profile for the member includes the member's measurements, race, interest and skills. The member is then asked a series of event type, music type and venue preferences questions to determine likes, dislikes and neutrality. The member can also input event ratings and reasons for unavailability into the member profile.

The application gathers data from third party sites such as member's external social media pages. This includes verification of profile data, education history and relationship status. The application gathers data on the member's social media friends lists, the member's likes, and photos or places that the member has been tagged in, as well as followers and who the member follows or subscribes to. Observed data that is included in the overall member profile consists of ambassador comments and tags, ratings of member performance at events, client comments and tags, and peer comments and tags. Additional observed data includes friends recommended to be cast by the member, previous attendance at specific venues, presentation score and staff vetting tags.

Behavioral data gathered by the present invention is made up of the member's engagement status, with different status indicators being: new, inactive, active online, active available and active attended. Frequency of engagement with the application is a kay factor as well. Other data segments include: frequency of profile updates; chat messages sent and received; likelihood to respond; likelihood of specific responses based on variety of event factors; time spent at the event or “on-site”; number of events previously attended; reliability, no-shows, and cancellations; number of times the member cast was declined or not cast; and number of referrals sent, attended and paid out.

In order to insure fulfillment of events being cast to meet client expectations, the present invention uses algorithms to predict the right offer. Each event earns a score based on what is called the combined total offer package, including incentives, location and venue or client reputation. This score will dictate what offer or offer package updates a client will need to make in order to fulfill their event with the desired amount of ideal attendees. The factors that make up this algorithm are: incentives (and subsequent weighted values); venue user reviews and third party sourced reviews from sites such as google or yelp; the brand and client social media influence or reach, response rate and member reviews; event type; event length; time of day; day of the week; special events and requirements such as social posts.

Facebook, Inc., describes a similar method to multiple incentive packages in its U.S. Pat. No. 8,768,774, titled: Advertisements with multiple targeting criteria bids. This patent describes an advertising system that enables the advertiser to associate multiple targeting criteria bids with the advertisement, including a combination of the bid amount and the criteria defining the users or targeted audience. Each criteria bid is associated with a different targeting criteria corresponding with a select group of users.

Data is aggregated from several sources to make up the overall event profile. Data collected straight from the client includes the company name, email, and phone number. Data collected from observers consists of ambassador comments and tags, as well as member comments and tags. Behavioral aggregated data consists of the events current engagement segment, frequency of engagement with the application, frequency of events, past ratings of events, frequency of profile updates, chat messages sent and received, likelihood of response and specific responses based on certain factors, time “on-site”, number of events that were previously cast, reliability and cancellations, and number of referrals.

Data is aggregated from several sources to make up the overall client profile. The client enters profile data into the application that includes the company and contact name, email and phone number. Observational data that is included in the client profile consists of ambassador, member, and staff comments and tags. Behavioral data included in the client profile consists of the current engagement segment, frequency of engagement with the application, frequency of events, past ratings of specific members, money spent per event, number of events held previously and the ability to deliver on promised incentives.

Facebook, Inc., describes a similar method to targeted online advertising in its U.S. Pat. No. 9,373,146, titled: Inferring target clusters based on social connections. This patent describes how clusters of users are gathered based on a set criteria of online behavior, and more users are retrieved within the social connections of the clustered users. Those retrieved users are then evaluated based on an algorithm to determine if they fit the targeted advertisement criteria. The automatic casting process described within the preferred embodiment creates specific groups of users by filtering the user database through a set of determined criteria and then evaluating said group using an algorithm.

To insure that the right people are matched to the right events, each member has an event specific rating based on how well suited they are for that particular event, based on the member profile, preferences, location and score. The factors included in this rating algorithm are: relative geo-location; data from previously attended events; event preferences; relative desirability; relative reliability; relative incentive preferences; venue ratings and historical performance.

In a manner similar to that of targeted advertising in a social networking environment, based on the behavioral characteristics of the user when engaged with the social network, the pricing and fulfillment engine must analyze data received by the client as well as all data exchange and interaction for users of the present invention. The interactive data is passed through the analytics algorithm of the pricing and fulfillment engine and used in processing client event requests. The pricing and fulfillment engine identifies which members will be the most ideal candidates to fulfill client attendance quotas.

These and other aspects, objects, features and advantages of the present invention, are specifically set forth in, or will become apparent from, the following detailed description of an exemplary embodiment of the invention.

### BRIEF DESCRIPTION OF THE DRAWINGS

FIG. 1 is the Overall View of the present invention;

FIG. 2 is a block diagram describing the Administrative Dashboard used to control access to the present invention by sponsors and or users and event participant;

FIG. 3 is a block diagram, which describes the Event Participant account sign-up interface;

FIG. 4 is a block diagram, which describes the Event Sponsor account sign-up interface;

FIG. 5 is a block diagram, which describes the Event Participant Dashboard/Participant Profile mobile application interface;

FIG. 6 is a block diagram, which describes the Event Participant Message mobile application interface;

FIG. 7 is a block diagram, which describes the Event Sponsor Location Dashboard accessed via the mobile application interface;

FIG. 8 is a block diagram, which describes the Event Sponsor Marketing Dashboard accessed via the mobile application interface;

FIG. 9 is a block diagram, which describes the Event Sponsor Casting Administrative control panel;

FIG. 10 is a block diagram, which describes the Additional Mobile Application Interface for Event Sponsors;

FIG. 11 is a block diagram, which describes the External Network server and Data Aggregation Processor;

FIG. 12 is a block diagram, which describes the Event Participant Profile registration information input interface;

FIG. 13 is a block diagram, which describes the Event Participant Attendance monitoring data mechanism used according to the present invention;

FIG. 14 is a block diagram, which describes an Event Request Input Interface containing administrator provided event details and guidelines;

FIG. 15 is a block diagram, which describes the Participant Casting Database used by the Administrator to select participants according to the present invention;

FIG. 16 is a System Overview of the Casting mechanism utilized according to the present invention;

FIG. 17 is a System Overview of the Administrator Control mechanism according to the present invention for participant casting criteria management set forth by the administrator;

FIG. 18 describes the member feature for event preference detection and management;

FIG. 19 describes the administrative feature for the pricing prediction algorithm;

FIG. 20 describes administrative features pertaining to filtering participants by implementing several key participant-related data aggregators.

FIG. 21 is a diagram of the pricing and fulfillment engine feature of the present invention.

FIG. 22 is a graph model showing how offer waves are formed by the pricing and fulfillment engine.

APPENDIX, Pages 1-27 describe a working embodiment of the present invention.

### DETAILED DESCRIPTION OF THE PREFERRED EMBODIMENT

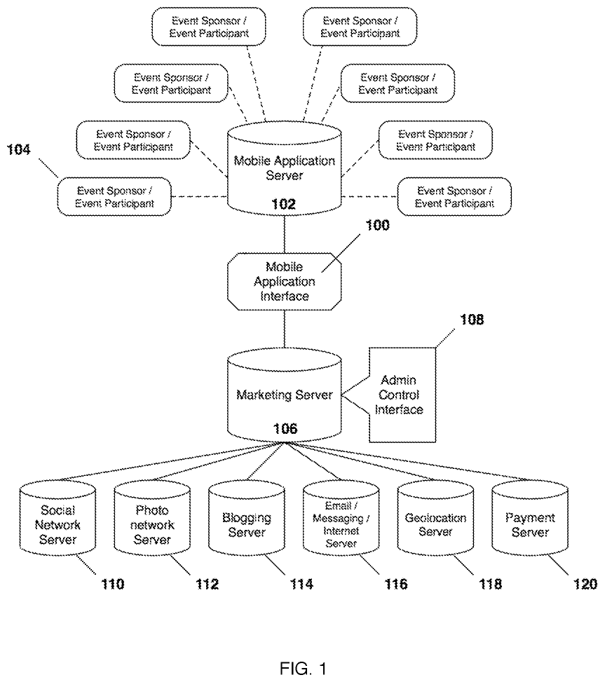

FIG. 1 is an overall view of a system according to the present invention. The present invention brings together a multitude of event sponsors with event participants. In accordance with the preferred embodiment of the present invention, event producers are screened by a system administrator so that the quality of events associated with the administrator are insured. Event producers may be associated with events such as movie premiers, nightlife activities, restaurants, television or movie castings, sporting events, concerts, promotional modeling, experiential events or any other situation where an event sponsor wants to assemble the “desired” crowd of people. Such a process may be known as CROWDCASTING™. According to the present invention, a mobile platform is configured to connect business interests with their respective target audiences, to form or “cast” the ideal crowd. Through the use of the present invention, promoters, public relations or marketing firms, casting agencies and public emailing may be augmented, focused and optimized, if not in some cases obviated.

Event producers may use the present invention as sponsors, providing invitations to prospective event attendees, even supplementing the most desirable attendees' invitations with incentives in the form of monetary payment or equivalent mechanisms. In turn, invitees may decide whether to accept or decline an invitation, depending upon the quality of the event, who else may have decided to attend, incentives offered and any of a multitude of criteria. The system draws in potential attendee qualifications from social media such as Facebook, Twitter and Instagram, but may draw in any of a multitude of criteria, so that potential invitees may be scored. Likewise, with attendance history, the present invention may be used to create a historical perspective as to event attendees, so that event sponsors know in advance which invitees tend to actually “show up” on time or at all, how their attitude and appearance are displayed at events attended, and so forth, so that in the future, event sponsors can ascertain who best to cast for specific events.

Event sponsors and event participants 104 with mobile devices can participate via a mobile application server 102. A mobile application interface 100 links the mobile application server 102 with the marketing server 106. An administrative control interface 108 allows the marketing server 106 to accomplish the objectives of the present invention. Likewise, the marketing server 106 interfaces with: social network servers 110; photo network servers 112; blogging servers 114; email and messaging servers 116 via the internet; geo-location services 118 and mapping servers; payment servers; and can also link up with any other servers to facilitate use of the present invention.

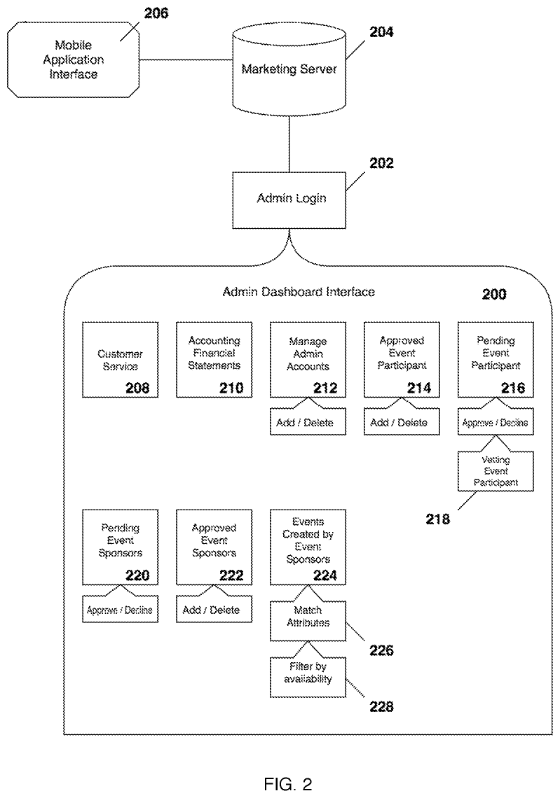

FIG. 2 provides an administrative dashboard for use with the present invention. In accordance with the preferred embodiment of the present invention, the administrative dashboard 200 is used to control the marketing system provided by the present invention. An administrator can only access the system by logging in 202 through the marketing server 204 on the mobile application interface 206, which permits access to various administrative functions such as: customer service 208; accounting and financial statements 210; the addition and deletion of administrative accounts 212; the addition and deletion of approved event participants 214; the addition and deletion of pending event participants 216 and the vetting process 218; the approval and declining of pending event sponsors 220; the addition and deletion of approved event sponsors 222; and the assembly of events created by event sponsors 224 with various match attributes 226 and availability filters 228.

An event participant is anyone who likes to have fun and wants to receive incentives to experience amazing events. Becoming an event participant is simple and it can end up compensating the attendee. With a simple instruction, an invitee can receive incentives, by downloading a computer application on their respective smart-phones, and register to become approved with the system administrator. Next, the users can receive availability requests with an incentive, and then the user can decide whether to accept or decline the invitation. Based on availability, the administrator and the event sponsor will cast various events and can in turn attend, have fun and even receive incentives.

Event producers are responsible for running local events and have the ability to cast events. Event producers must sign up in advance to be producers under the marketing system according to the present invention, and seek approval of the system administrator. Once approved, event producers can past crowds and fill venues with crowds they deem “perfect”. One administrator called SURKUS™ has referred to this process as CROWDCASTING™. Various matching techniques, and administrator control processes may be used, by various administrators, so that event sponsors or event users can reach out to precisely the “preferred” crowd. This mechanism is akin to the way actors are cast for parts in movies. By utilizing a combination of push and pull strategies to connect to a large audience with specific brands, events and experiences and then utilizes the network to engage target customers.

By way of example, the objectives of the event producer may be optimized. Social media influencers are drawn from the roster of many individuals for a given event. On site data includes that the users check in to a given event, and are rated as to their appearance and the impression or engagement score they make overall. Accordingly, ratings can be developed as to event attendees. In addition, prospective attendees may be scored and rated based on tangible qualities. Events may have leaders or ambassadors. Criteria such as hair color, eye color, physical appearance, body type, ethnicity, and other typical matching criteria may be assessed and lead to an overall score, along with the number of followers you have in social media. In that manner, social media influencer status may be ascertained.

Event details are very important to define according to the present invention. The event may be assigned a title, and event details as detailed as desired. Parking and transportation may be provided, and various incentives may apply as to various event attendees.

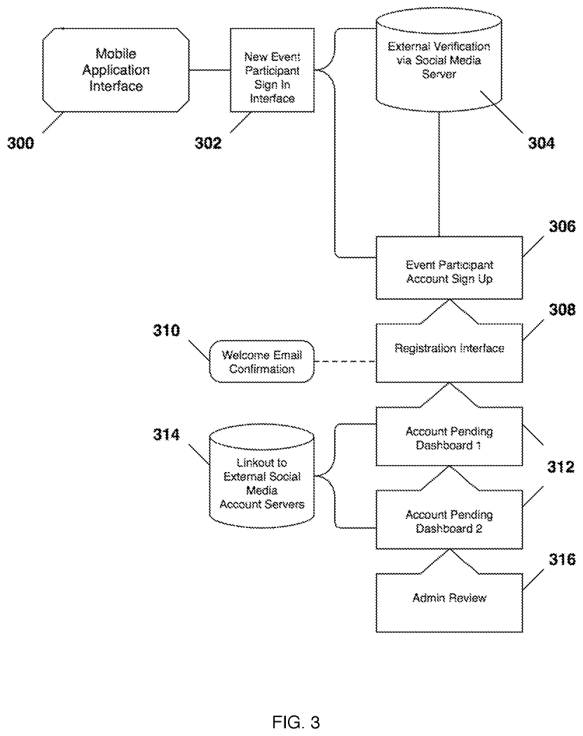

FIG. 3 describes the new event participant account sign-up interface. In accordance with the preferred embodiment of the present invention, external verification is done through external social media servers. An event participant begins by setting up a new account through the sign in interface 302 through the mobile application 300. The data entered by the participant is verified through an external social media server 304, permitting the participant to sign up for an account 306. The participant completes the sign up process through the registration interface 308 and a welcome email 310 is sent to confirm the new account. The account status remains as pending 312 with links to the new participant's social media account servers 314. The pending account is then reviewed by the administrator 316 to complete verification and activate the account.

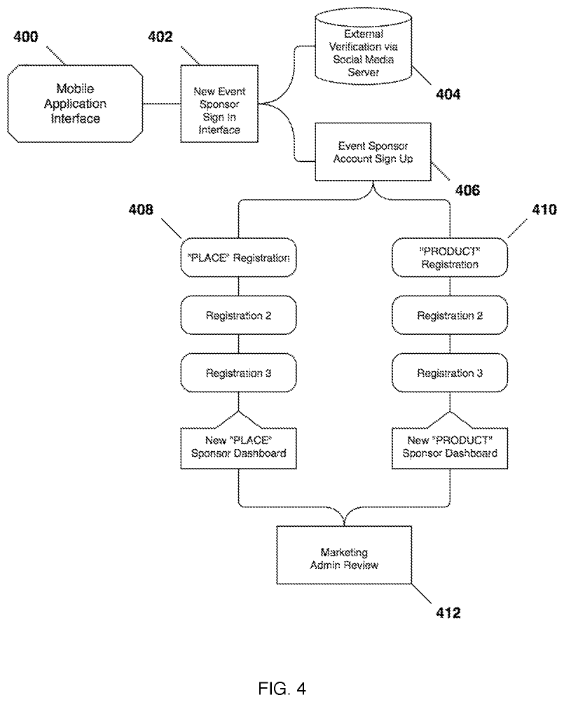

FIG. 4 describes the new event sponsor account sign-up interface. In accordance with the preferred embodiment of the present invention, sponsors are responsible for providing events. A potential event sponsor can sign up for a new account on the sign in interface 402 on the mobile application interface 400. The potential event sponsor is then verified through an external social media server 404, whereby the event sponsor completes the account sign up process 406 by registering as a “place” event sponsor 408 or “product” event sponsor 410. The account remains pending until reviewed and approved by the system marketing administrator 412. The administrator of the event organizing system or marketing system according to the present invention, such as the company SURKUS™, must be careful to screen event producers as their universe of event attendees or invitees or so-called “SURKUSgoers™” are essentially a valuable asset, and exposing attendees to poorly organized events will diminish the effectiveness of the marketing system in the future. Accordingly, the administrator according to the present invention, such as SURKUS™, may introduce stringent quality control standards upon people or entities seeking to become event producers or event sponsors.

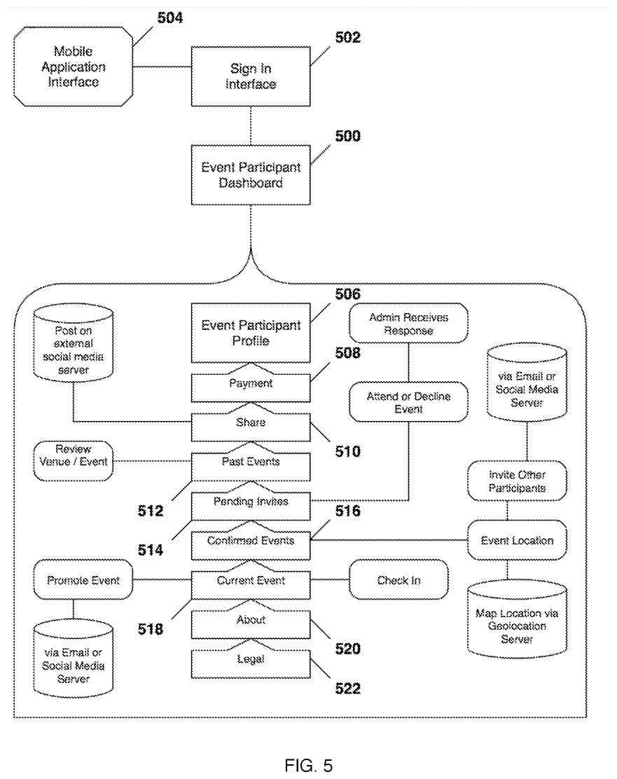

FIG. 5 describes the event participant dashboard 500, and references the participant profile 506 accessed by signing in 502 to the participant account dashboard 500 via the mobile application 504. The event participant profile 506 interface allows the participant to: access the payment portal 508; share information on external social media accounts 510; review past events 512; view pending invites 514; view confirmed events 516; check in or promote a current event 518; view information about the mobile application 520 and view legal information 522. Event attendees undergo a vetting and selection process, so that they may choose to attend events they feel they will enjoy, have fun at, profit from via incentives and professional networking and other career motivated criteria. For the first time with the present invention, social media influencers may automatically gain and monetize value from being attractive and engaging. Indeed, social media influencers reach that status by being so engaging, and so, the present invention enables them to receive incentives for having achieved that status.

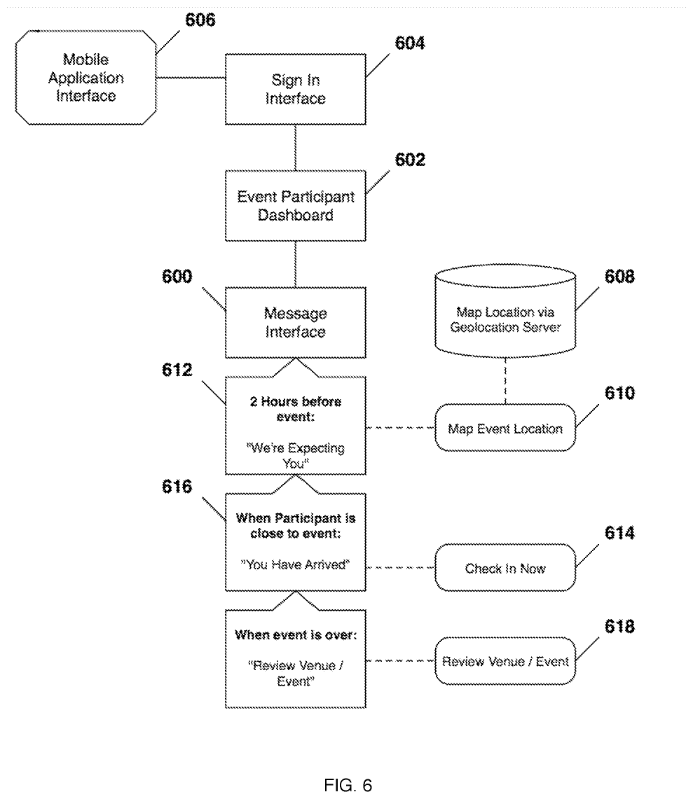

FIG. 6 describes the event participant message interface 600 accessed by signing in 604 to the participant account 602 via the mobile application interface 606. In accordance with the preferred embodiment of the present invention, event participants are located via GPS 608 and venue map locations 610 are provided, with directions and a “we're expecting you” message, to facilitate attendance by event participants. A participant may be required to “check in” 614 when they have arrived at an event, and sent an arrival confirmation message 616. Also, during the course of the event, a participant may be scored according to his or her engagement, that is, how they interact with other event participants and sponsors. Reviews of the events are taken by both event sponsors and event attendees or participants 618. Accordingly, event sponsors may find that they have an easier time filling future events with lower incentives by producing events that are deemed desirable by attendees. Attendees may be communicated with by event sponsors in order to stimulate various actions or qualities among event attendees attending pursuant to the system according to the present invention.

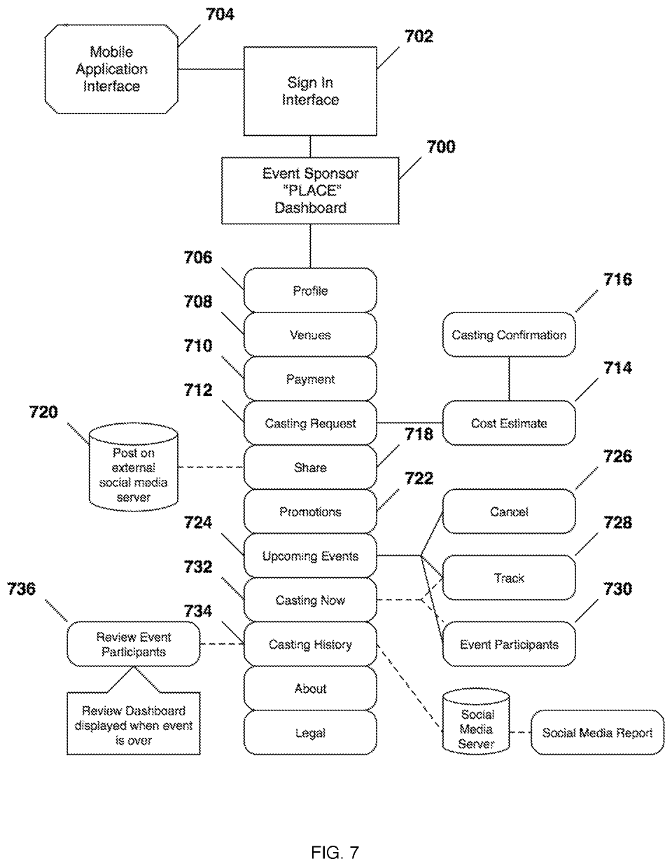

FIG. 7 describes the event sponsor site for location-based events. In accordance with the preferred embodiment of the present invention, the Event Sponsor “place” dashboard 700 is accessed by signing in 702 to the sponsor account via the mobile application interface 704. The event sponsor has a “place” dashboard it may use to control an event. The dashboard permits the event sponsor to access: the sponsor profile 706; venues 708; the payment portal 710; casting requests 712 including casting confirmations 716 and event cost estimates 714; sharing status updates 718 on external social media servers 720; promotions 722; upcoming events 724 including cancelled events 726, event status tracking 728 and attending event participants 730; casting for current events 732 as well as previous casting history 734; review of event participants 736 and other pertinent information available to event sponsors or event producers.

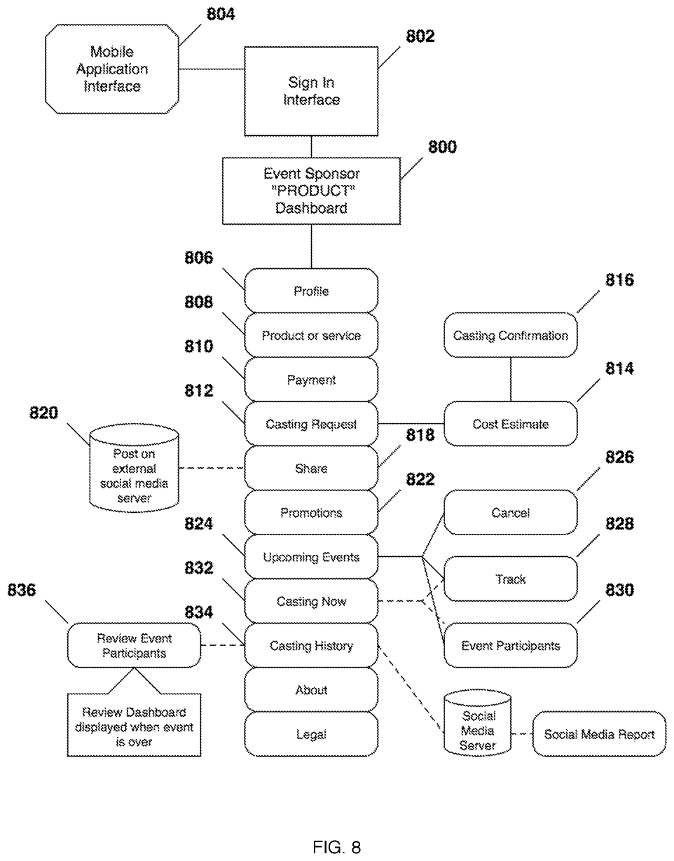

FIG. 8 describes the event sponsor “product” (marketing product or service) dashboard accessed by signing in to the sponsor account via the mobile application. In accordance with the preferred embodiment of the present invention, the Event Sponsor “product” dashboard 800 is accessed by signing in 802 to the sponsor account via the mobile application interface 804. The event sponsor has a “place” dashboard it may use to control an event. The dashboard permits the event sponsor to access: the sponsor profile 806; list of products and services 808; the payment portal 810; casting requests 812 including casting confirmations 816 and event cost estimates 814; sharing status updates 818 on external social media servers 820; promotions 822; upcoming events 824 including cancelled events 826, event status tracking 828 and attending event participants 830; casting for current events 832 as well as previous casting history 834; review of event participants 836 and other pertinent information available to event sponsors or event producers.

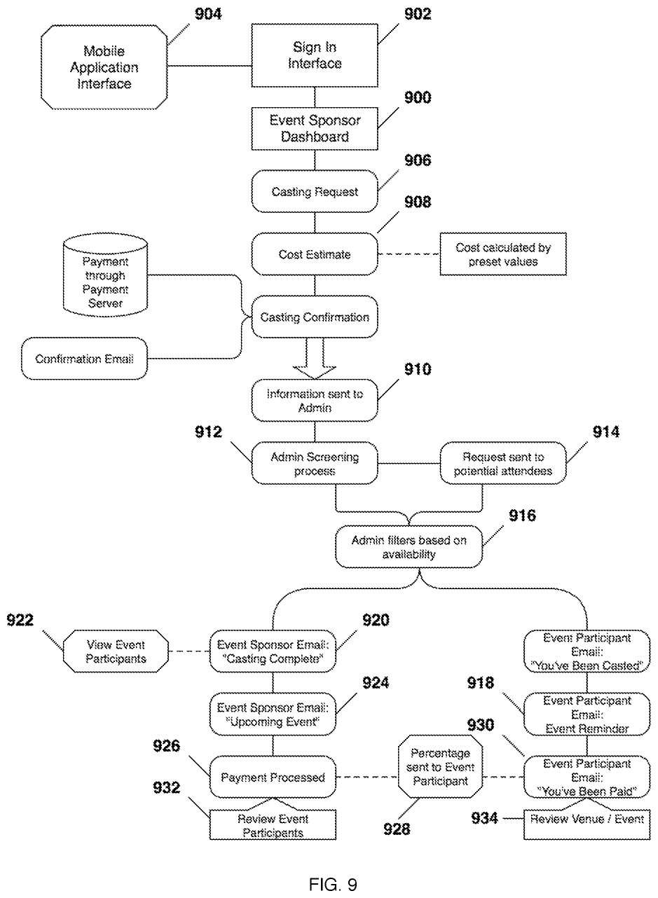

FIG. 9 describes the event sponsor casting overview and administrative casting request control panel overview. In accordance with the preferred embodiment of the present invention, the event sponsor accesses the dashboard 900 by signing in 902 through the mobile application interface 904 and completing a casting request 906 for an event. Once the casting request information is complete, a cost estimate 908 is provided to the event sponsor and the casting request is submitted to administrator for review to the administrator 910. The administrator reviews the request 912 and selects potential attendees 914, filtered based on the availability of the attendees 916. Once the event participant verifies that they are able to attend the event, they are sent verification notices and reminders via email 918.

After the event participants have been verified, a notification 920 is sent to the event sponsor that allows the sponsor to view the event participants 922. An event reminder notification is also sent to the event sponsor prior to the event 924. The event sponsor then processes payment 926 and a percentage of that payment is then allocated to the attending event participant 928. The event participant is notified that they have been paid for attending the event 930. The event sponsor submits a review 932 of the event participant and the event participant submits a review 934 of the venue and event. The review information serves as analytical data stored on the application server.

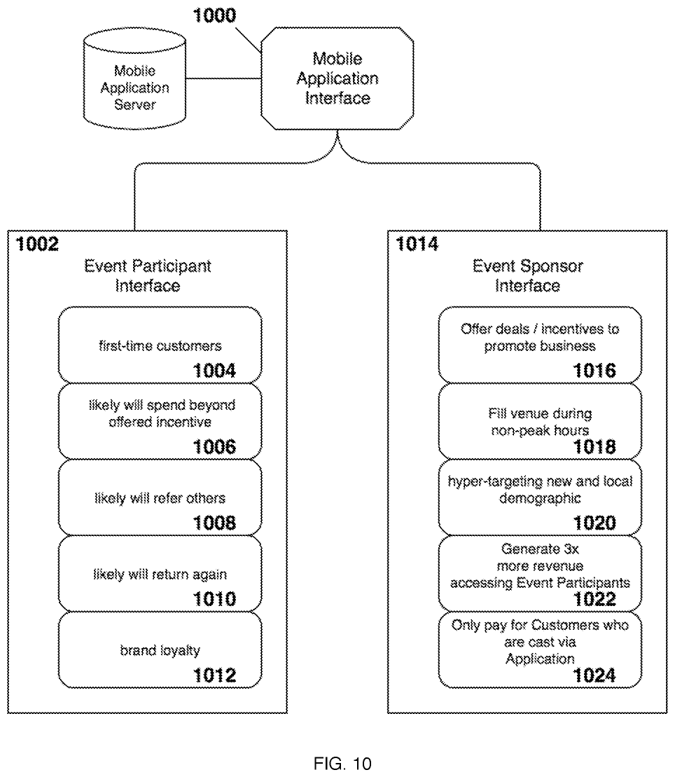

FIG. 10 describes the additional mobile application interface 1000 for event sponsors to market to a select group of event participants. In accordance with the preferred embodiment of the present invention, event participants are filtered and selected based on a specific set of criteria through the event participant interface 1002. The event participant is considered a first time customer 1004 if they have not attended a previous event held by the event sponsor. Based on prior attendance and review data, the application interface can determine how likely the participant will spend beyond the offered event sponsor incentive 1006, how likely the participant will refer others to the event 1008 and how likely the participant will return to future event sponsor events 1010. The application interface also uses prior aggregated data to determine the event participant's brand loyalty relative to an event sponsor 1012.

The event sponsor can use the event sponsor interface 1014 to offer deals and incentives to event participants 1016 as a means of promoting the event sponsor's business. This allows the event sponsor to fill a venue during non-peak hours by submitting an event request to select event participants 1018. Event participants are filtered using specific criteria that allows the event sponsor to narrowly define the type of event participant for the event based on factors such as geolocation and proximity, known as “hyper-targeting” 1020. The event sponsor can generate increased revenue based on having access to specific event participants 1022 and the event participant is only required to pay for event participants who will attend the event via the application interface 1024.

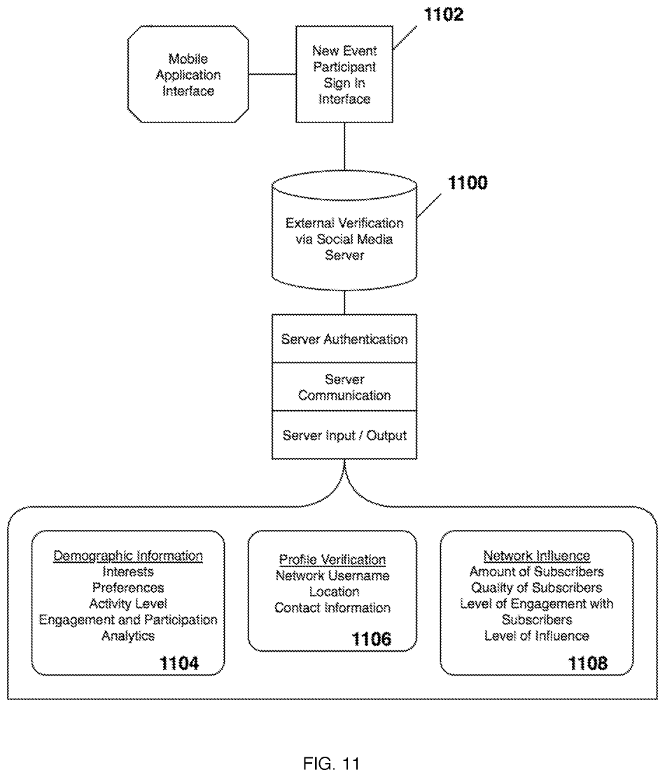

FIG. 11 describes the external network server verification and data aggregation processor from the event participant's social networks that are utilized as a component of the AUTOCASTING™ administrator controlled process. In accordance with the preferred embodiment of the present invention, through the initial sign-up interface 1102, an event participant provides external social network information that allows the application to verify the new participant and access data in the external social network server 1100. This data is aggregated and applied to the event participant profile to facilitate the automatic casting process. Demographic information 1104 such as interests, preferences, activity level and participation are collected from the external social network server 1000. The participant is verified by the external social network server based on username, location and contact information 1106. The participant's external social network influence data is collected, including the amount and quality of subscribers, level of subscriber engagement and level of participant influence 1108.

By the term AUTOCASTING™, the inventor is referring to a trademark utilized by the company SURKUS™. AUTOCASTING™ refers to optimizing the audience mix for events. Venues have a desire to attract desirable new customers and brand representatives to their locations, simultaneously maximizing on-site spending by customers and minimizing the overall marketing expenditure to achieve increased brand awareness. Venues to-date have been limited to traditional advertising mediums to target users, with the inherent limitations in targeting criteria and accuracy in achieving ideal results. According to the present invention, an administrator may utilize a well-developed, metadata-rich, geo-centric database of opt-in consumers who provide a cross section of socio-graphic, demographic and behavioral characteristics. When venues seek to cast an event, a platform according to the present invention allows for filtering a target audience list with specific “MUST HAVE” criteria such as age range, gender, and affinities for specific complementary brands. After creating a subsection of a desired audience that is both geographically desirable for an event, and meets all of the “MUST HAVE” criteria, a desired target list may be derived, and the target list may end up much larger than the desired attendee count. In that case, the system according to the present invention may be used to apply additional optimization criteria specific to the business desires. For example, a business can choose to maximize first-time attendees, maximize social media influencers, or minimize cost. Based on this objective, the platform can assign appropriate weights to individual users in the system, then automatically invite a random selection of higher weighted users until enough target attendees have indicated availability for the event. Accordingly, the crowd may be assembled in various orders to fill an event in any desired manner. This process of automatically casting events is a significant improvement over traditional audience generation techniques in many ways. Namely, on several fronts: 1. It supports micro-targeting customers based on socio-graphic, demographic, and behavioral attributes previously only accessible to online marketing platforms; 2. It is highly automated, requiring only configuration of the requirements, at which time the system completely automates the selection of audience and identifying user availability; 3. It requires and leverages a metadata-rich user database, which removes human-bias from traditional “casting” or invite-only based event management; and 4. It provides an increasing amount of internally generated metadata, which can be used to further improve the performance of the platform as a whole.

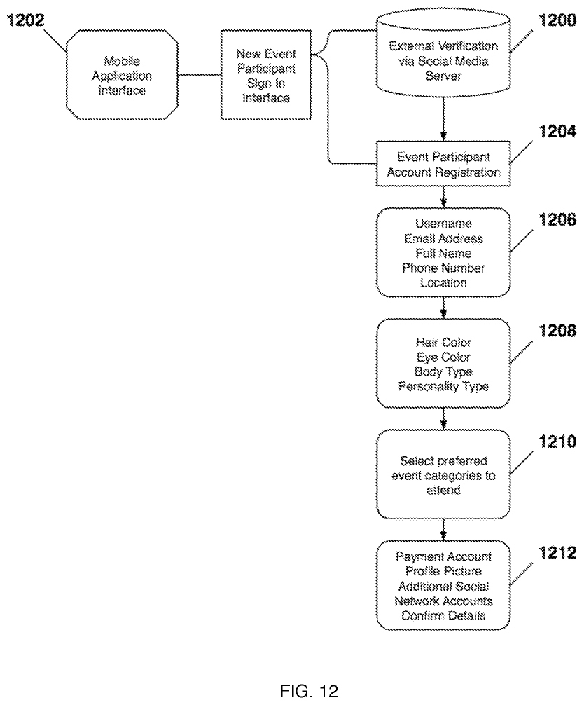

FIG. 12 describes the event participant profile registration information input interface whereby profile data is used as a component of the automatic casting process. In accordance with the preferred embodiment of the present invention, external social network information is aggregated and verified 1200 by the mobile application interface 1202, the event participant registers for a participant profile by entering relevant data 1204. In the first panel, the event participant enters a username, email address, full name, phone number and location 1206. The second panel requires the event participant to submit basic physical characteristics such as the hair color, eye color, body type and personality 1208. The third registration panel allows the participant to select the preferred event categories that they wish to attend 1210. The fourth registration panel requires that the participant submits a payment account, a profile picture and additional external social network accounts that are confirmed by the mobile application 1212.

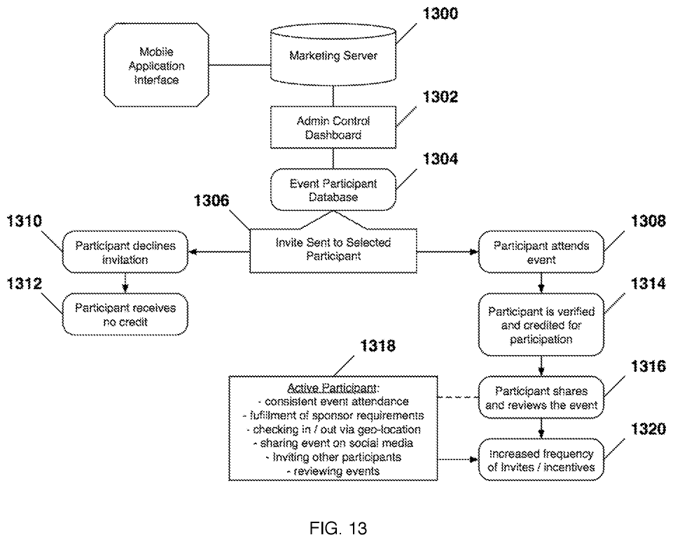

FIG. 13 describes the event participant activity level or event attendance at various events. Monitoring said data is a way for the present invention to implement its automatic casting process. Within the application marketing server 1300, the administrator can access the administrator control dashboard 1302 and the event participant database 1304. Once an event participant is selected, an invite is sent 1306 whereby the participant must confirm if they will attend the event 1308. If the event participant declines the invitation 1310, no credit is received 1312. If the event participant confirms the invitation and attend the event, attendance is confirmed and the participant is credited 1314. By sharing the event information on external social media servers and reviewing the event 1316, the participant is then considered an active participant 1318 in the automatic casting process and becomes more visible in the event participant database. The increased visibility creates an increase in the frequency of invites and incentives for the event participant 1320. To be credited as an active participant 1318, the participant is required to have a consistent record of event attendance, fulfill sponsor requested requirements, use geo-location to check in and check out of the event, share the event on external social media servers, invite other participants and review attended events.

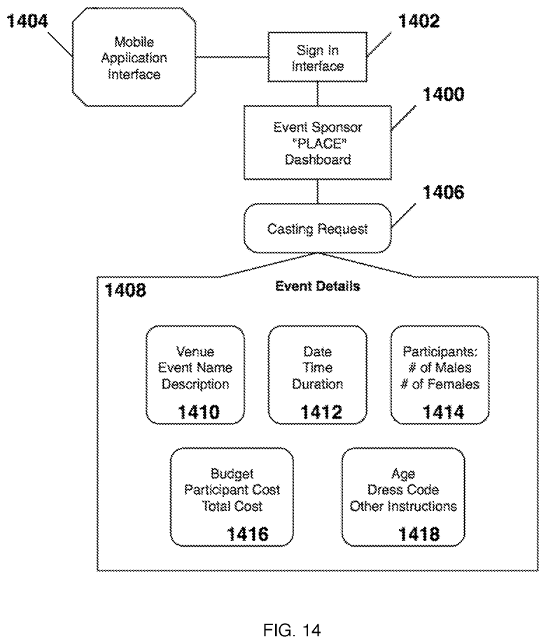

FIG. 14 describes an event request input interface containing the event sponsor's event details and guidelines that are submitted to the administrator and user as a component of the automatic casting process. In accordance with the preferred embodiment of the present invention, the event sponsor accesses the sponsor dashboard 1400 by signing in 1402 to the mobile application interface 1404. Once the event sponsor has signed in, they are able to complete an event casting request 1406. The event sponsor is required to complete the following event details 1408: the venue, event name and description 1410; the time, date and duration 1412; the amount of male and female participants requested 1414; the budget, participant cost and total cost of the event 1416; and the age of participants, dress code and other instructions 1418. This data is used to filter specific participants in the automatic casting process. The casting request is then sent to the administrator for review.

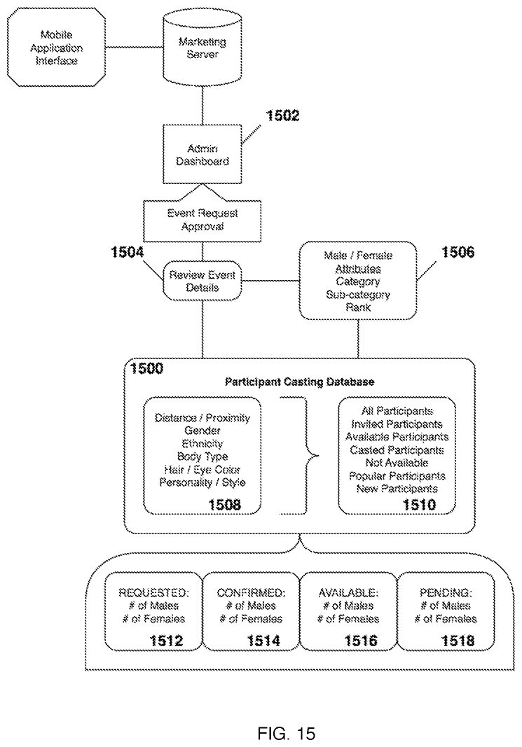

FIG. 15 describes the participant casting database 1500 used by the administrator to select participants to be invited to an administrator reviewed and approved event. According to the present invention, an administrator 1502 may use data compiled from the event sponsor and participant profile as a filtering module within the automatic casting process. Once the administrator reviews and approves the event request 1504, the administrator uses the event detail information to filter specific participants in the participant casting database 1500. Male and female attributes are filtered based on the event category, sub-category and rank of the participant based on aggregated profile data 1506. Filters 1508 are applied to the event participant casting database that include: distance and proximity to the event; gender, ethnicity and body type of the participant; hair and eye color; and the participant personality and style. The participant casting database also displays relevant casting information 1510 including: the total amount of participants; the number of currently invited participants; the number of available participants; the number of casted participants; the number of not available participants; the number of popular or high-ranking participants; and the number of new participants. Once event participants are selected and sent event request invitations, the database also displays: the number of requested male and female participants 1512; the number of confirmed male and female participants 1514; the number of available male and female participants 1516; and the number of pending male and female participants 1518. The automatic casting process is complete once a certain number of event participants have been confirmed to attend the event, and the event participant information is send to the event sponsor.

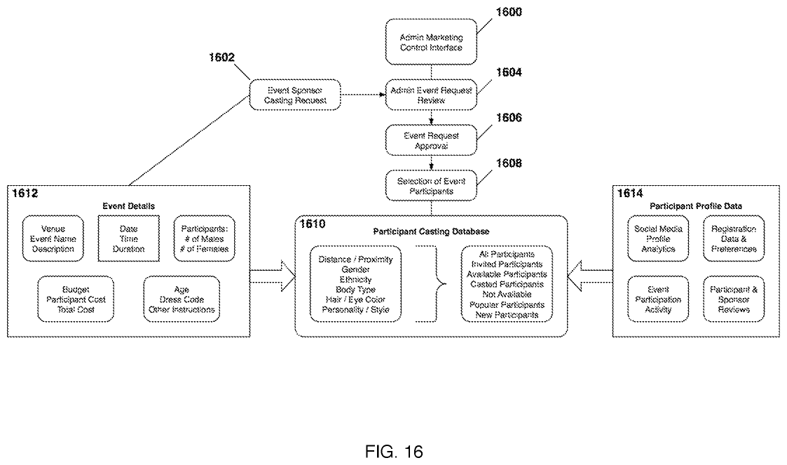

FIG. 16 is a system overview of the automatic casting process. In accordance with the preferred embodiment of the present invention, the process may be embodied as an administrator controlled process 1600 whereby data is aggregated from event sponsors and event participants and utilized in the administrator controlled participant casting database. The event sponsor submits an event casting request 1602 containing event details 1612 to the administrator. The administrator reviews the event details 1604 and approves the event 1606 to select event participants 1608. The administrator implements the automatic casting process in the participant casting database 1610, whereby event detail data 1612 is entered to filter event participants based on data from each participant profile 1614.

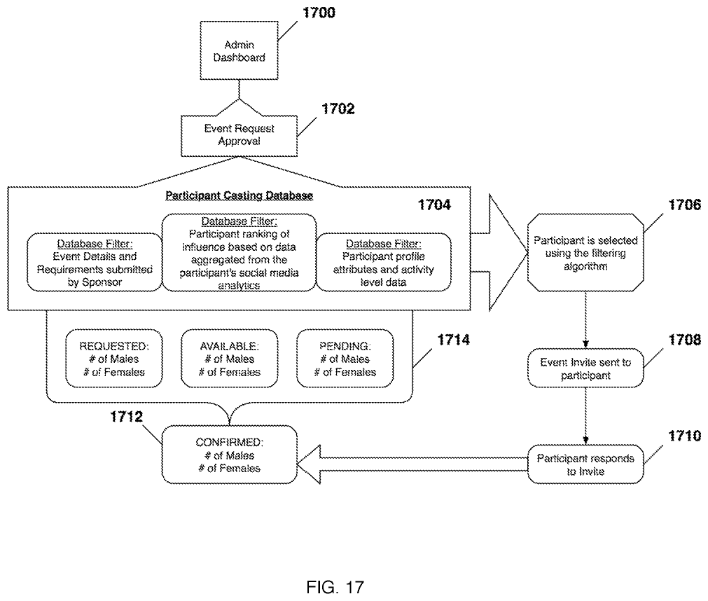

FIG. 17 is an administrator overview as an administrator applies specific filters to the participant casting database that enables the automatic casting process according to the present invention. In accordance with the preferred embodiment of the present invention, that process is used to select optimal participants for a given event. Through the administrator dashboard 1700, the administrator approves the event request 1702 and uses the participant casting database 1704 to select participants using the filtering algorithm 1706. The selected participants are then sent an invitation to the event 1708 and their response 1710 is used by the administrator to complete the event casting process. The participant response to the invitation is then submitted to the administrator participant casting database and the data 1712 is implemented into the total amount of confirmed male and female participants 1714. This process continues until the specified amount of event participants have confirmed that they will be attending the event.

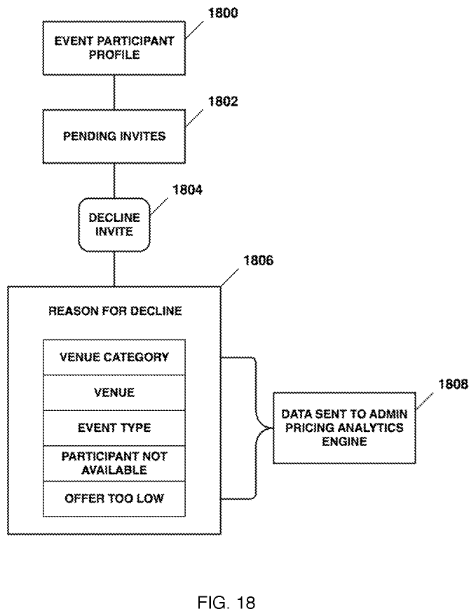

FIG. 18 describes the member feature for event preference detection and management.

In accordance with the preferred embodiment of the present invention, an event participant logs in to his or her participant profile 1800 to review all pending invites 1802 that require a response. If the participant chooses to decline an invite 1804, the participant must provide a reason for the decline through the decline dialog screen 1806. Options for declining an invite include: participant dislikes venue category; participant dislikes venue; participant dislikes the event type; the participant is not available; or the offer presented to the participant is too low to attend. The reason for decline chosen by the participant is then transmitted to the administrator portal as data to be used in the pricing analytics engine algorithm 1808.

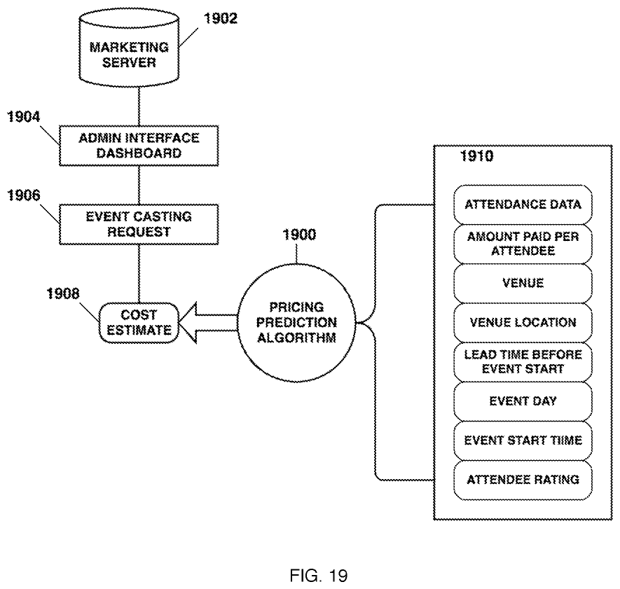

FIG. 19 describes the administrative feature for the pricing prediction algorithm. In accordance with the preferred embodiment of the present invention, the pricing prediction algorithm 1900 is used to provide an accurate estimate of how much an event will cost, providing a cost estimate 1908 for a specific event casting request 1906. The pricing prediction algorithm 1900 can be accessed through the admin interface dashboard 1904 located on the application marketing server 1902. The pricing prediction algorithm 1900 consists of a data-based model 1910 that aggregates event history and attendance data. This data includes but is not limited to: attendance data; amount paid per attendee; the venue and venue location; the lead time before an event starts; the event day of the week; the event start time and the average attendee rating. Using the resulting model, one can enter speculative values for a new event, including the venue; start time; and desired attendee rating to obtain the cost that should be offered to fill the event with the provided requirements. The target cost includes a specific value and a variance factor that represents the confidence of a result. The person generating the predicted cost may adjust values to see how they affect the target cost, and use the information to negotiate with clients in order to optimize the cost for an event.

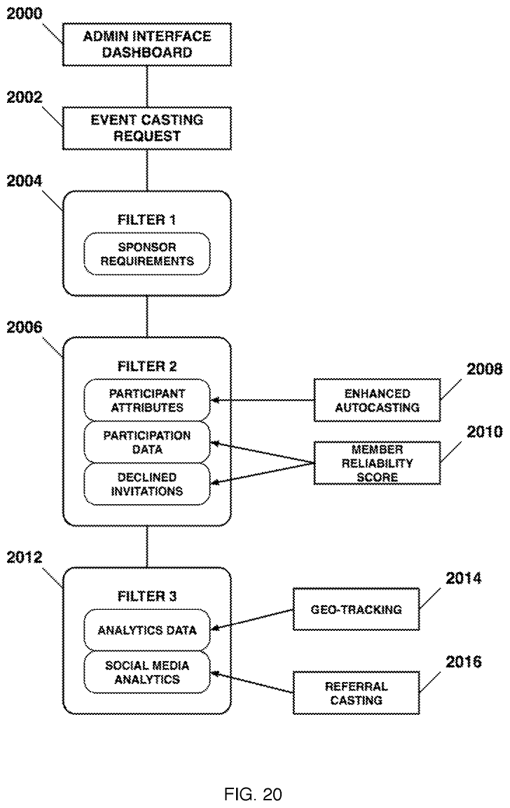

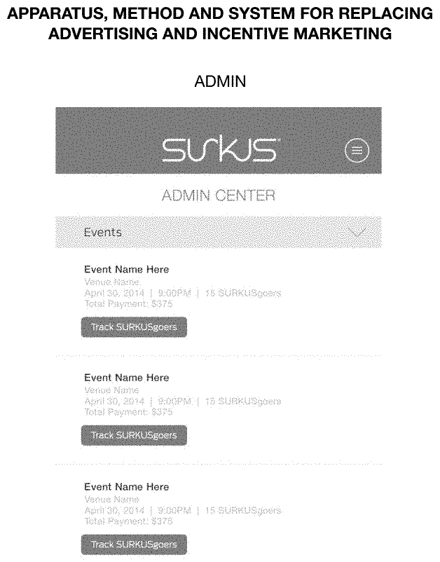

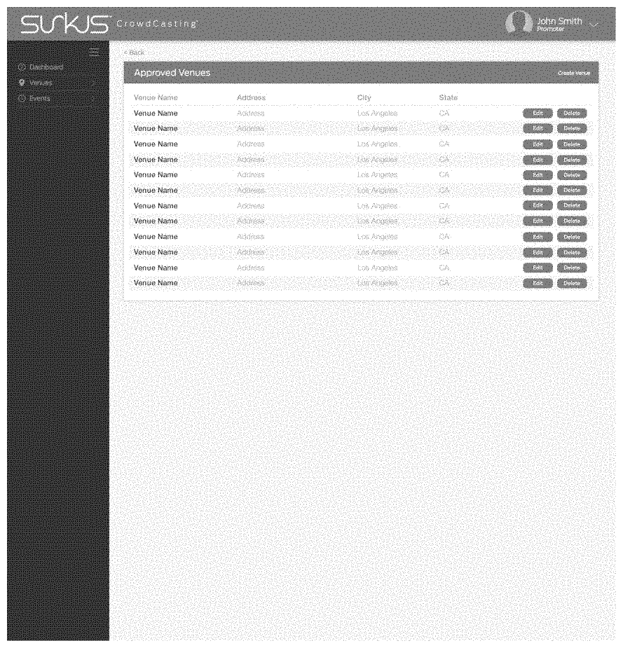

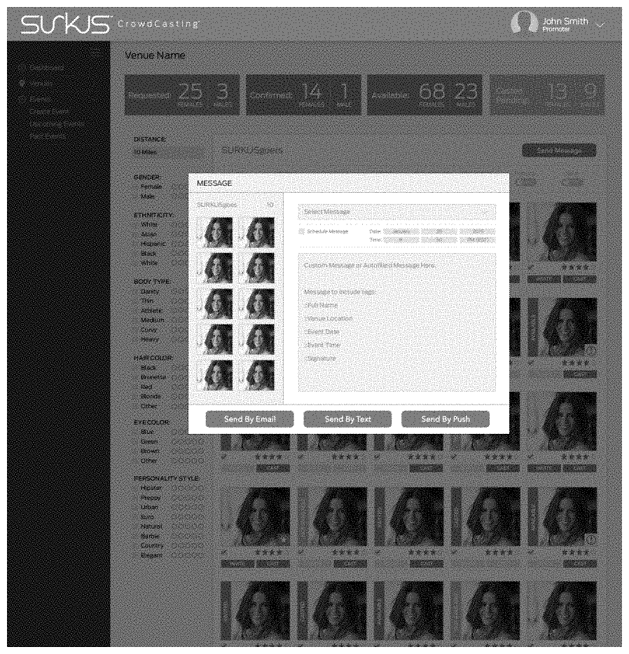

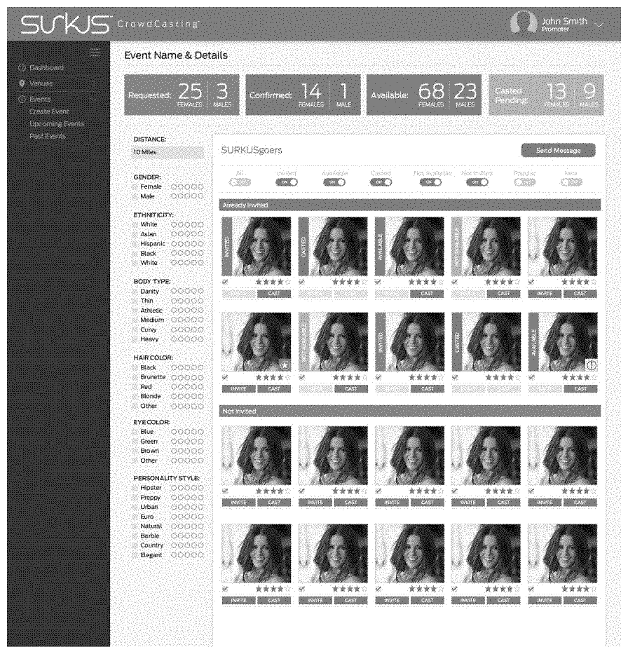

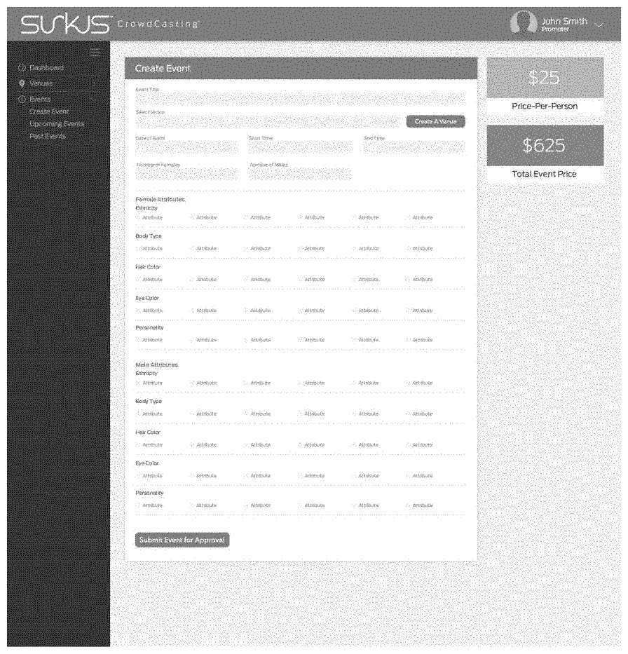

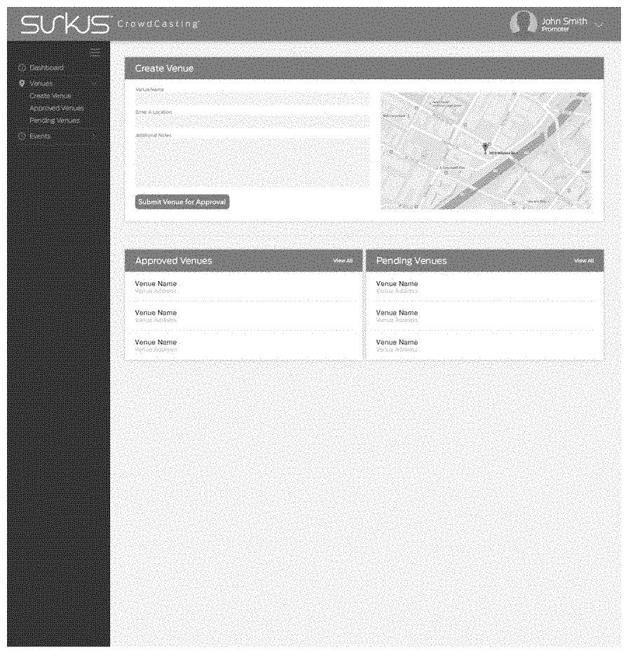

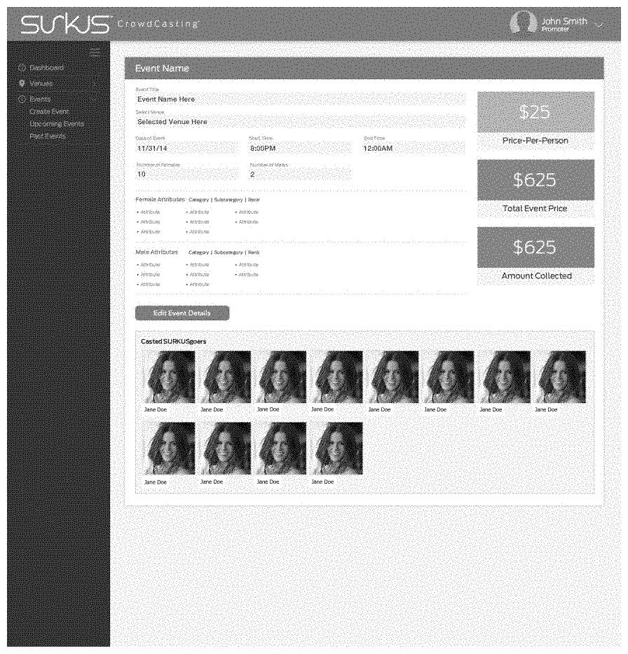

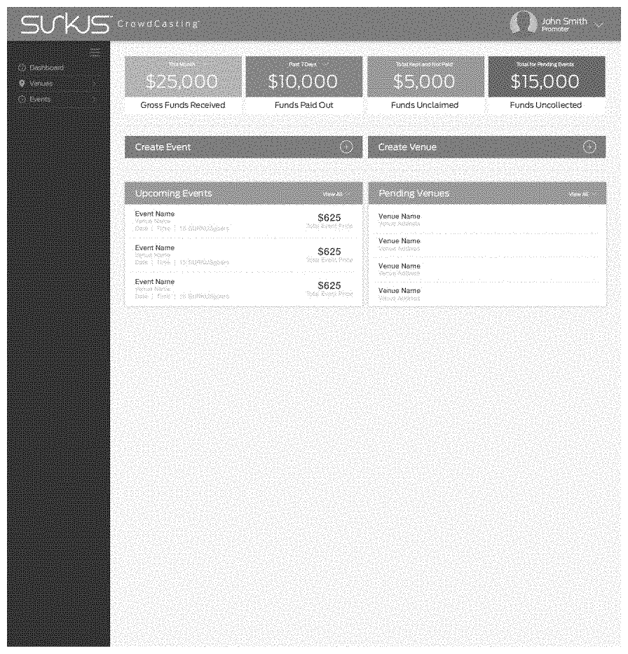

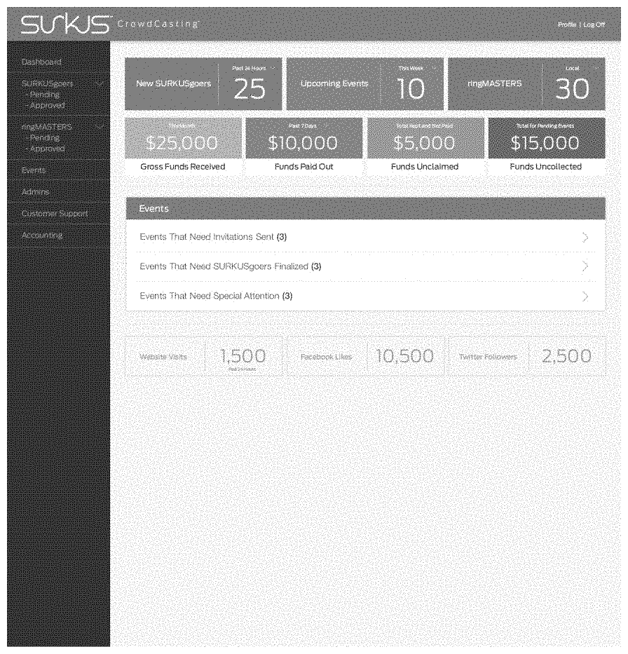

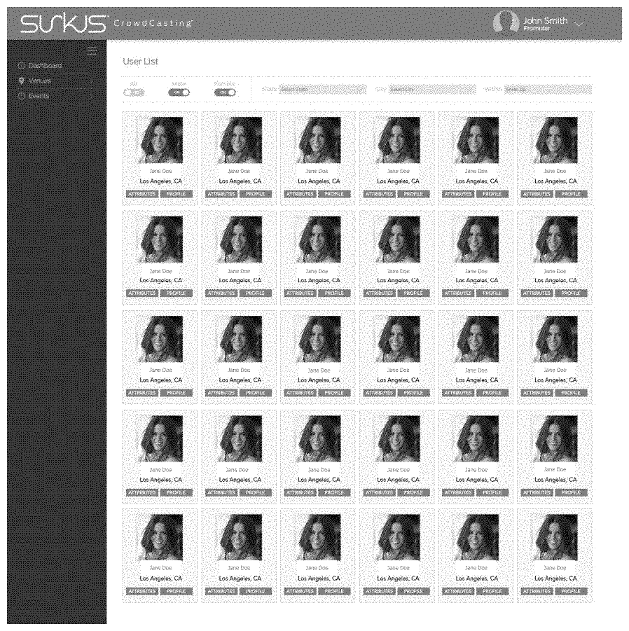

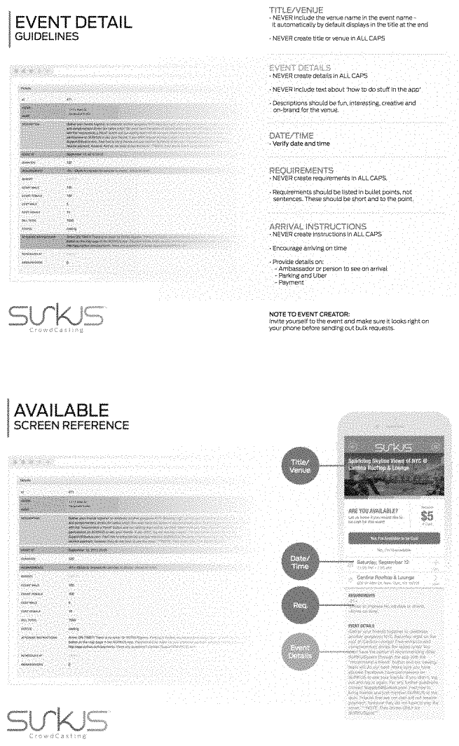

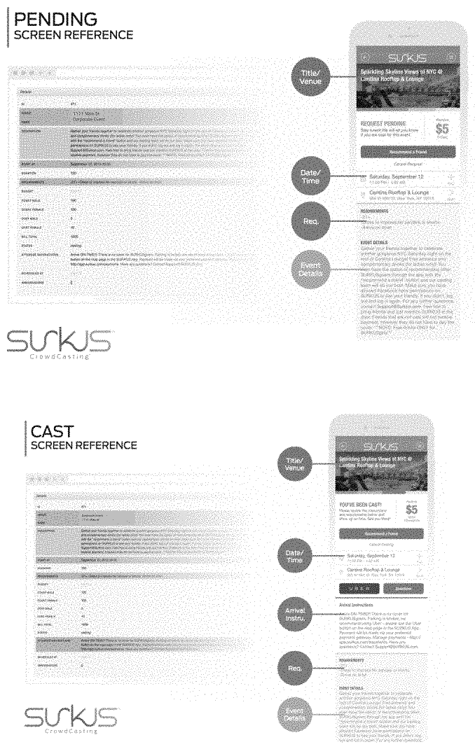

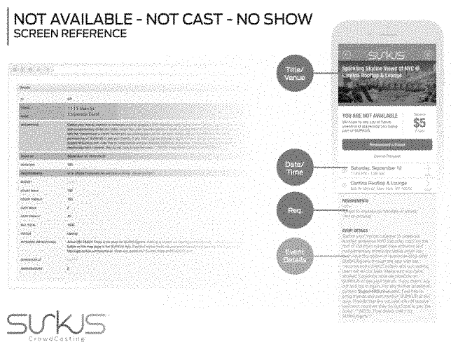

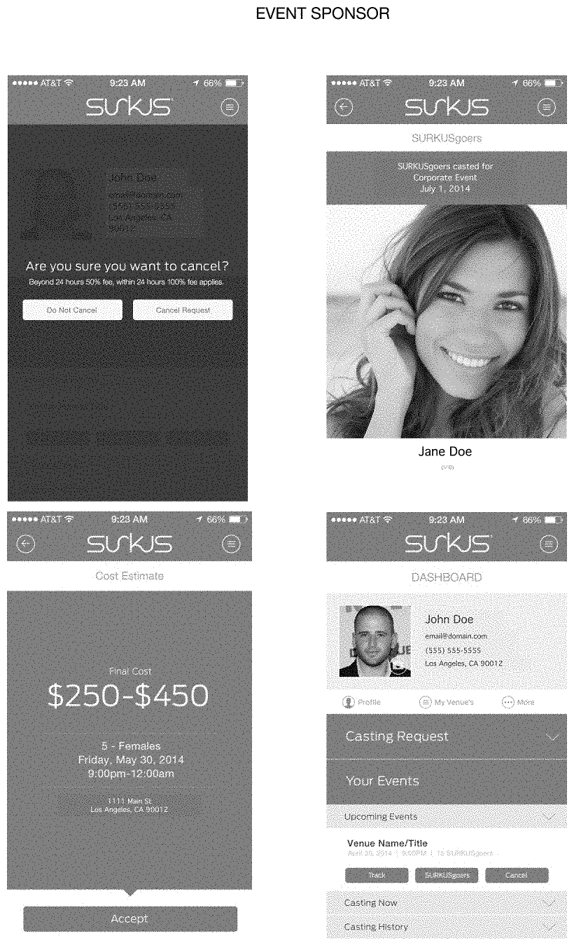

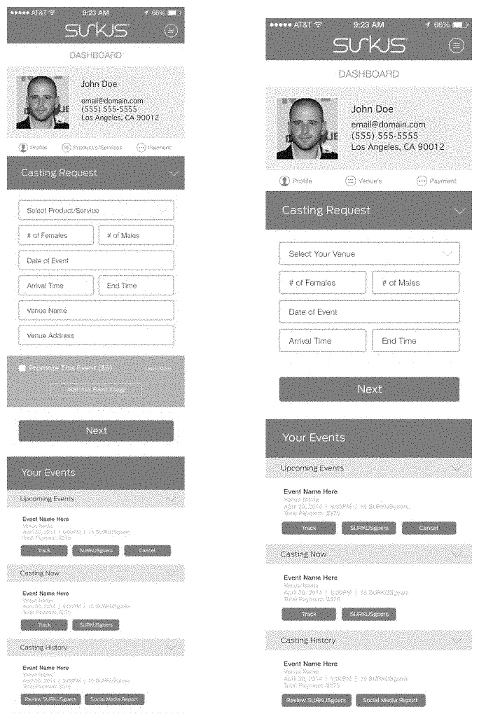

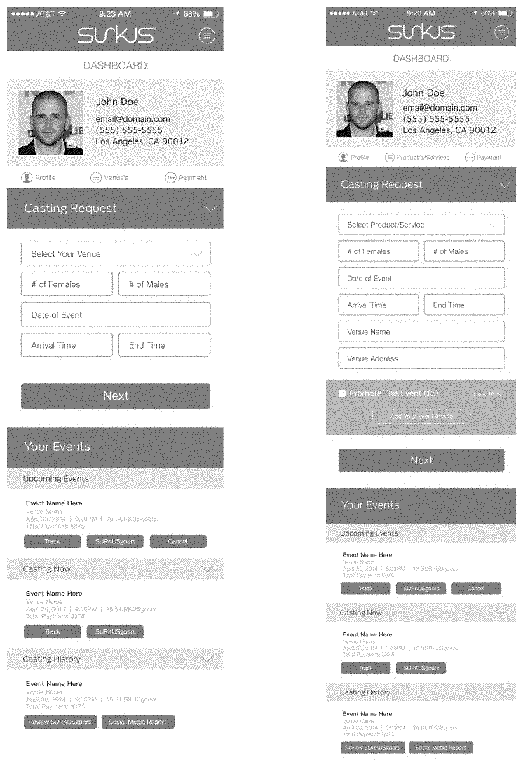

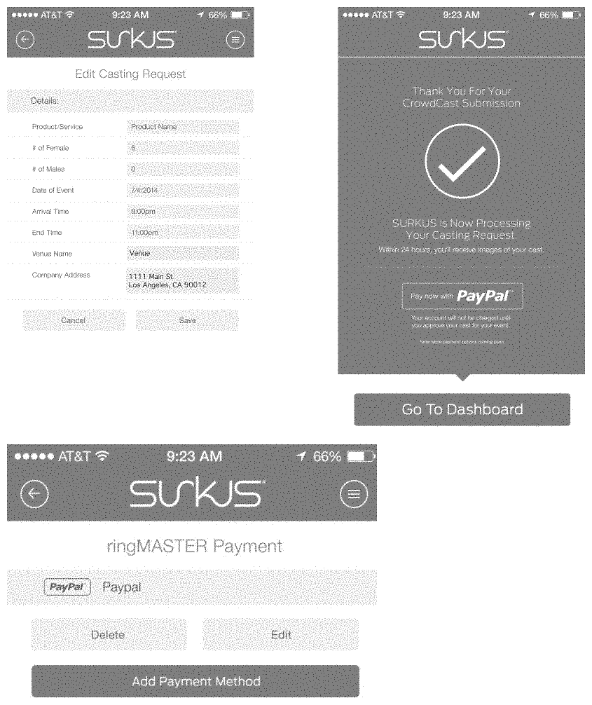

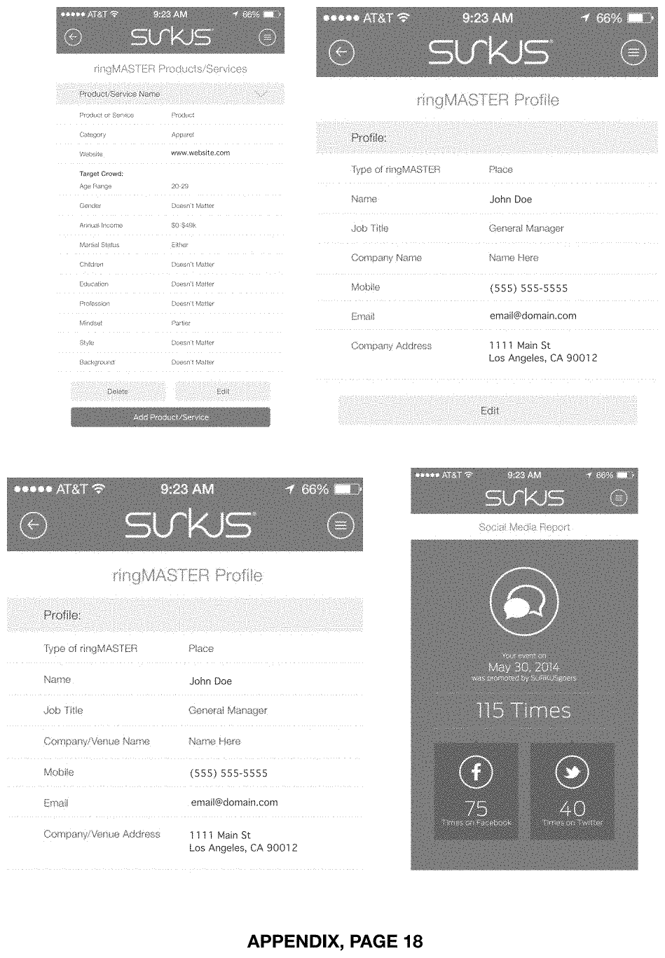

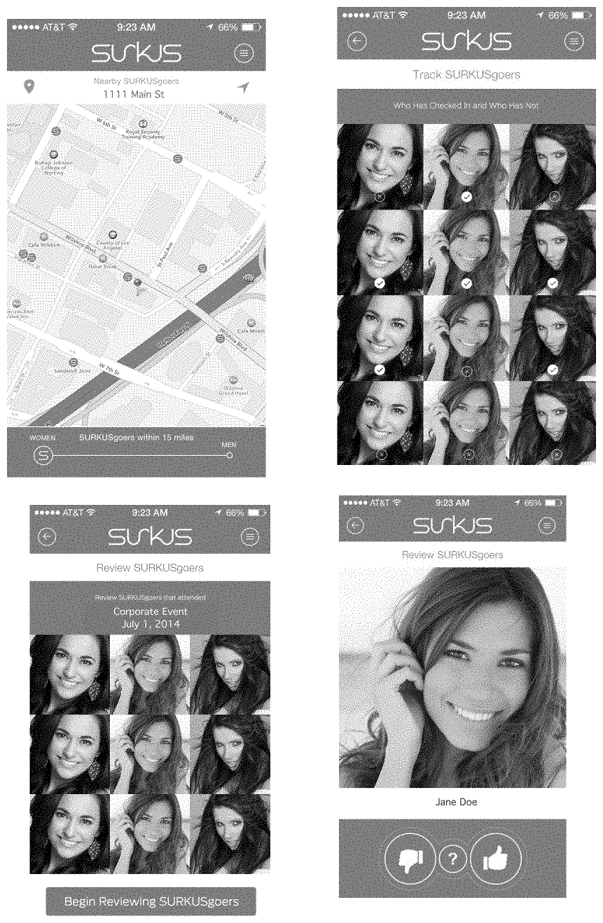

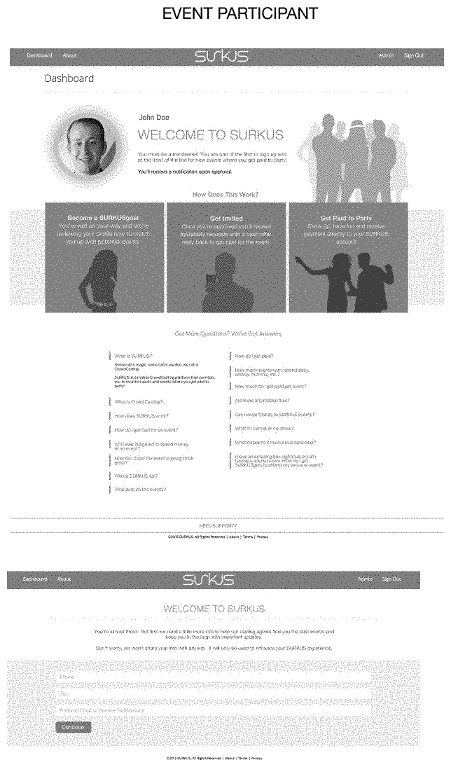

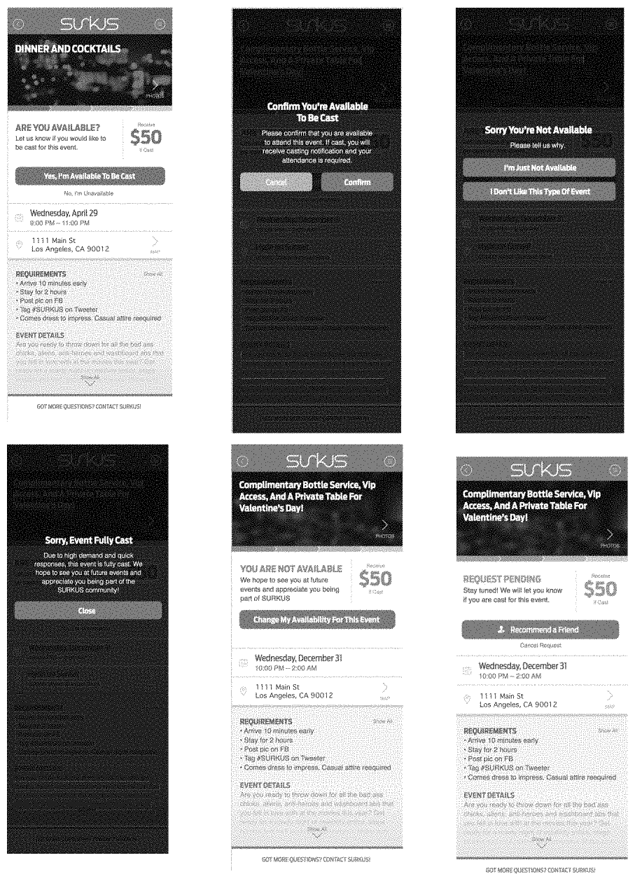

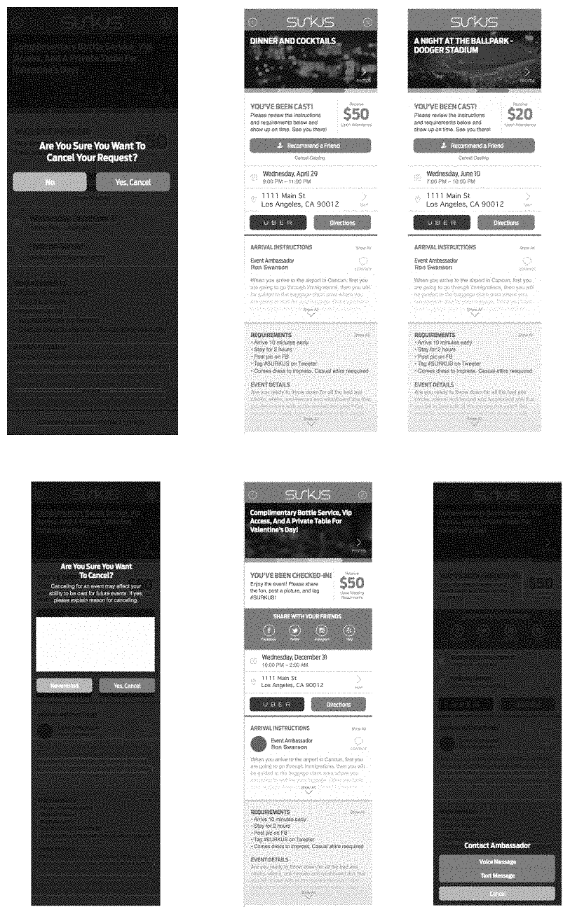

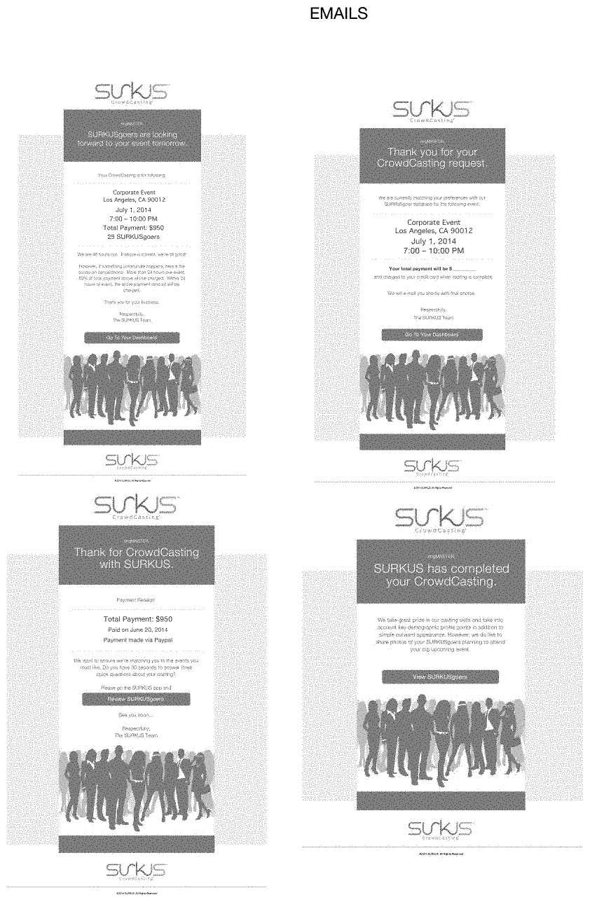

FIG. 20 describes administrative features pertaining to filtering participants by implementing several key participant-related data aggregators. In accordance with the preferred embodiment of the present invention, the administrator uses the admin interface dashboard 2000 to view event casting requests 2002 in order to cast each event. The administrator implements a series of filters, starting with Filter 1 2004, consisting of sponsor requirements for casting the event. Filter 2 2006 is then implemented to further narrow the participant casting database, consisting of participant profile attributes; participation data and ratio of declined invitations per participant. Filter 2 2006 implements the enhanced Autocasting feature 2008. Casting active members allows for the system to reach casting targets more efficiently, while filtering out non-active members to be re-engaged by the system marketing department. The enhanced

Autocasting 2008 feature takes member event preferences into account, ensuring that users who have demonstrated a dis-interest in certain types of events will not receive off-target or undesirable event requests. Filter 2 2006 also implements the use of a member reliability score system 2010. This system provides a sorting option for the casting administrator by leveraging a beta distribution based on attendance at prior events to estimate reliability for upcoming events. The beta distribution allows for members who have not yet attended to be fairly considered while converging on consistent reliability scores as more attendance data points are collected for each member. Filter 3 2012 implements participant profile analytics data and external social media analytics data. Background geo-tracking 2014 contributes to participant analytics data by periodically capturing the physical location of participant's phones to accurately calculate the distance between a participant and an upcoming event. Distance to venue is the single most relevant factor for event casting. Geo-tracking 2014 also allows for the application to detect when a participant is traveling, opening up opportunities for the marketing administrator to offer special event attending promotions and incentives. Referral casting 2016 is used within Filter 3 2012 to filter the participants that are more likely to invite or recommend events to others. From the administrative dashboard 2000, the casting system has access to the micro-networks of referrals for a particular event, enabling the administrator to use this data to cast clusters of participants for an event. Attending with friends has improves the attendance rate and lower the cost requirements to get participants to attend an event.

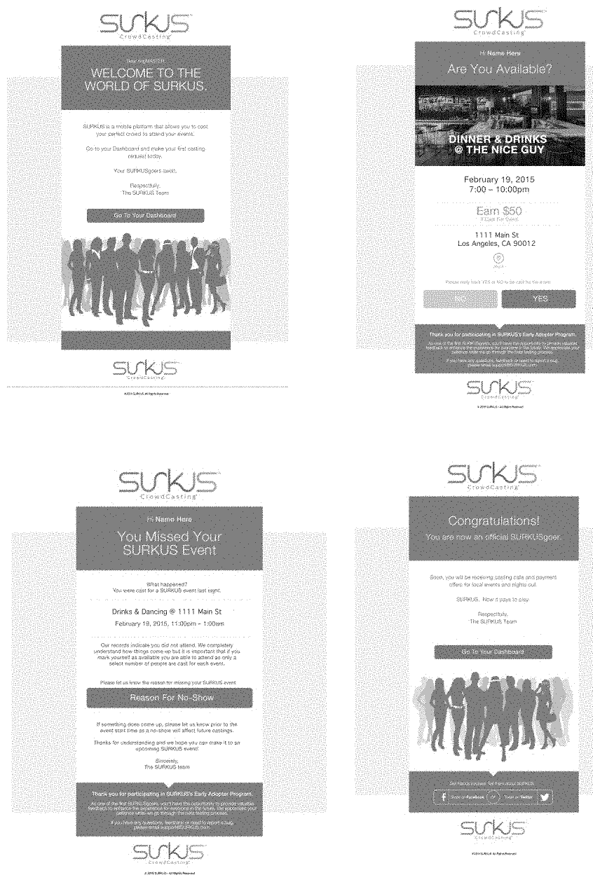

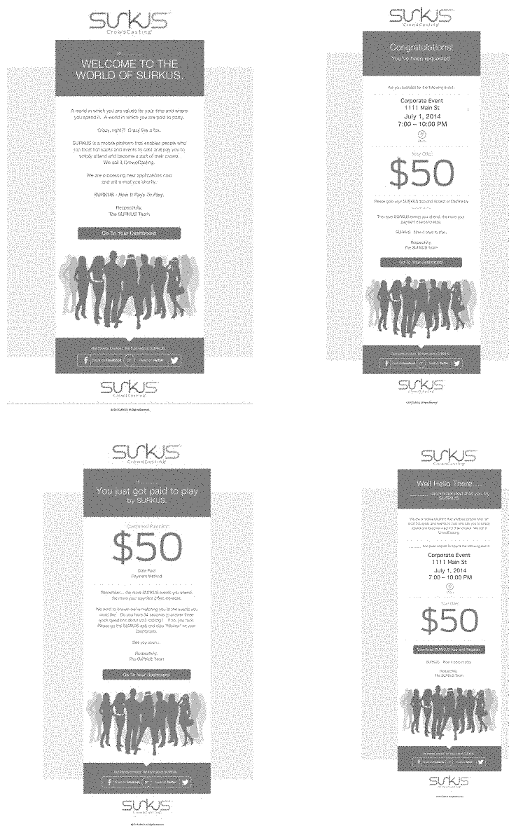

FIG. 21 is a diagram of the pricing and fulfillment engine feature of the present invention. In accordance with the preferred embodiment of the present invention, the pricing and fulfillment engine 2100 analyses data input by the client 2102 in order to determine the ideal offer and optimal invite targets to fill the client's desired attendance quota. The client 2102 creates an event 2104 through data entry into the application.

The client 2102 enters an initial cost offer package and desired attendance quota that is analyzed by the pricing and fulfillment engine 2100, whereby the cost, made up of the expected monetary offer amount and desired margin, is transmitted back to the client 2102 for acceptance. The pricing and fulfillment engine 2100 can predict fulfillment in real time, learning and adapting over time based on historical evidence, with a bias towards recent data over older data. Once the cost is accepted by the client 2102, the pricing and fulfillment 2100 engine analyses the event data 2104 to determine the ideal members with the highest probability of accepting and attending the event. The member casting process is executed in three waves: the first offer wave 2106 sends out an invite to the most ideal members, determined by financial incentive and member points, whereby a majority of the attendance quota is filled; the second wave 2108 sends out more invites to the next tier of members, determined by financial incentive and member points; the third invite wave 2110 is sent to the third group of members who are determined to be good matches for the event, in order to fill the remaining attendance quota. Within the third wave, a member rating bonus is also added to provide additional incentive for good matches to earn more points by attending.

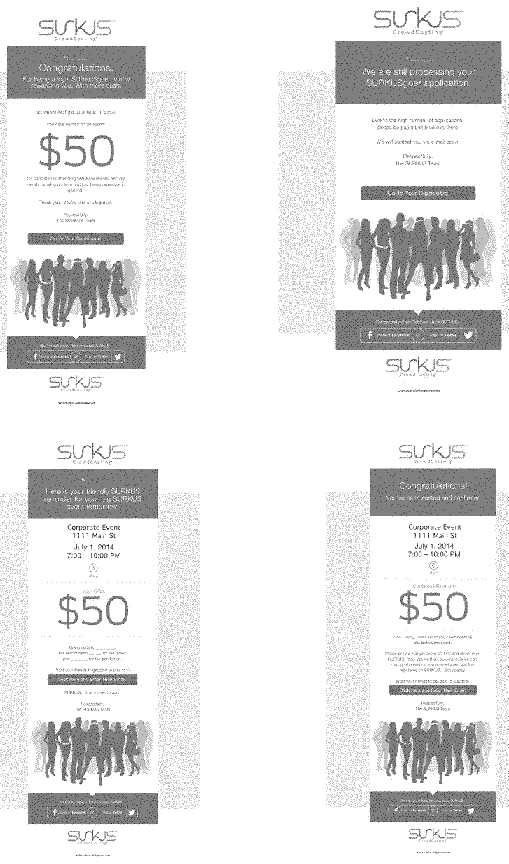

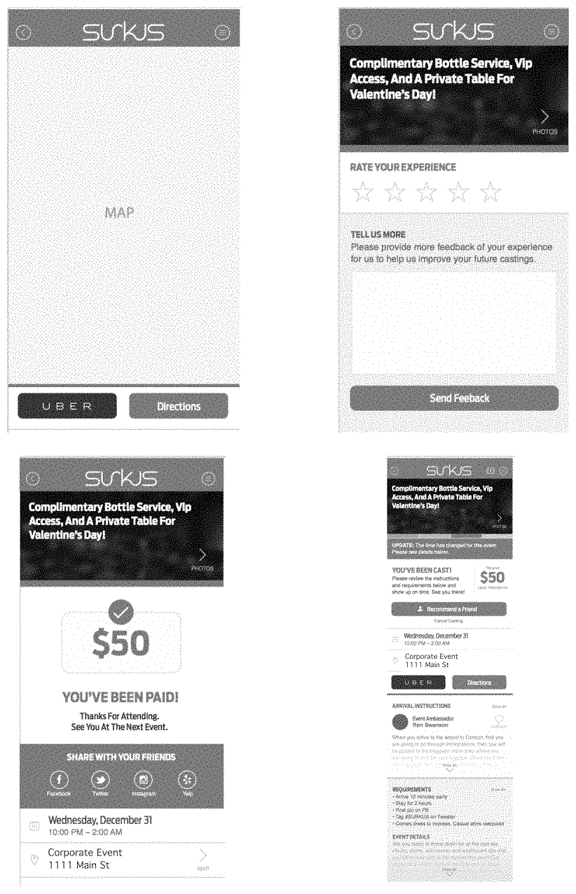

FIG. 22 is a graph model showing how offer waves are formed by the pricing and fulfillment engine. In accordance with the preferred embodiment of the present invention, offer wave initiatives sent to members to fulfill attendance to an event are formed by the pricing and fulfillment engine identifying and prioritizing important traits of the client's event request. The invite candidates are auto-grouped in clusters according to their relative ratings of those traits, and offers are sent out in segmented waves at a pre-determined pace until the event is subsequently cast. The candidates in the first wave 2200 meet the highest ratings criteria for the determined factors. The candidates in the second wave 2202 rate lower on the determined criteria than the first wave, however they still have good ratings in at least two of the three determined factors. The third wave of candidates 2204 have a a high rating in at least one of the determined event categories.

### APPENDIX

Pages 1-27 illustrate a working embodiment of the present invention. Pages 1-10 illustrate the administrator dashboard for event casting and payments. Pages 11-13 illustrate the event invite and casting screens. Pages 14-19 illustrate the event sponsor dashboards for event requests, event payment and attending participants. Pages 20-22 illustrate the event participant dashboard for viewing, accepting or declining event requests. Pages 23-27 illustrate email incentives and reminders sent to event participants from the marketing administrator.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future. It is intended that the following claims be interpreted to cover all such obvious alterations and modifications.

What is claimed is:

1. A method for replacing advertising comprising the steps of:
selecting users for participation at a live event;
comparing a user attribute database with a desired user attribute for attendance at said live event as selected by an event sponsor;
deriving from said comparison a guest list for said live event representative of the user attributes selected by said event sponsor;
notifying said guest list of users of their selection for participation of said live event;
recording qualitative and quantitative data indicative of said selected guest list of users actually in attendance at said live event, and recording which of said selected guest list of users who decline to or otherwise fail to attend said live event;
deriving a payment process by which each of said users in attendance at said live event are paid for their attendance, in an amount sufficiently high to populate said event, but efficiently calculated to not over pay for said attendance; and
annotating said user attribute database with criteria indicative of user's performance at said live event so that future live events may be more effectively populated with the most advantageous users possible.
